(19) United States
(12) Patent Application Publication
(10) Pub. No.: US 2025/0365386 A1
(43) Pub. Date: Nov. 27, 2025

(54) INFORMATION PROCESSING APPARATUS, METHOD, AND NON-TRANSITORY COMPUTER-READABLE STORAGE MEDIUM STORING PROGRAM

(71) Applicant: CANON KABUSHIKI KAISHA, Tokyo (JP)

(72) Inventor: TAKASHI OKAZAWA, Tokyo (JP)

(21) Appl. No.: 19/209,985

(22) Filed: May 16, 2025

(30) Foreign Application Priority Data
May 21, 2024 (JP) 2024-082895

(51) Int. Cl. H04N 1/60; G01J 3/52

(52) U.S. Cl. CPC H04N 1/6033; G01J 3/52

(57) ABSTRACT

In a case where measurement corresponding to a first server among a plurality of servers is performed, a display control unit corresponding to the first server displays the result of the measurement of a measurement device. And in a case where the measurement corresponding to the first server is switched to measurement corresponding to a second server, in a state in which the measurement corresponding to the first server is interrupted, a measurement device control unit stores the result of the measurement of the measurement device performed before the interruption.

### BACKGROUND

### Field of the Technology

The present disclosure relates to an information processing apparatus communicable with a color validation server, a method in the information processing apparatus, and a non-transitory computer-readable storage medium storing a program.

### Description of the Related Art

In the commercial printing field, there is known a color validation system for performing a color validation process of periodically verifying color quality of an image forming apparatus using a Web browser on an information processing apparatus (Japanese Patent Laid-Open No. 2023-102149). In the color validation system, a color validation application operates on the server side. Then, a Web browser connected via a network communicates, as a client, with the color validation application.

### SUMMARY

The present disclosure provides an information processing apparatus for improving convenience in resuming measurement processing, a method, and a non-transitory computer-readable storage medium storing a program.

The present disclosure in one aspect provides an information processing apparatus communicable with a plurality of servers, comprising at least one memory and at least one processor causing the information processing apparatus to function as: a measurement device control unit configured to control a measurement device to perform measurement for a measurement target and store a result of the measurement of the measurement device; and a display control unit corresponding to each of the plurality of servers and configured to control to display the result of the measurement of the measurement device stored by the measurement device control unit, wherein in a case where measurement corresponding to a first server among the plurality of servers is performed, the display control unit corresponding to the first server displays the result of the measurement of the measurement device, and in a case where the measurement corresponding to the first server is switched to measurement corresponding to a second server, in a state in which the measurement corresponding to the first server is interrupted, the measurement device control unit stores the result of the measurement of the measurement device performed before the interruption.

According to the present disclosure, it is possible to improve convenience in resuming measurement processing.

Features of the present disclosure will become apparent from the following description of embodiments with reference to the attached drawings. The following description of embodiments are described by way of example.

### BRIEF DESCRIPTION OF THE DRAWINGS

FIGS. 1A and 1B are views each showing the configuration of a color validation system;

FIG. 2 is a block diagram showing the configuration of an information processing apparatus;

FIG. 3 is a block diagram showing the functional block configuration of the color validation system;

FIGS. 4A and 4B are views each showing the configuration of a Web page;

FIG. 5 is a view showing a measurement setting screen;

FIGS. 6A and 6B are views showing a measurement execution screen;

FIGS. 7A and 7B are views showing the measurement execution screen;

FIGS. 8A and 8B are views each showing a screen indicating a color validation result;

FIGS. 9A and 9B are flowcharts for explaining the procedure of measurement processing;

FIGS. 10A to 10C are sequence charts showing the sequence of the measurement processing;

FIGS. 11A and 11B are sequence charts showing the sequence of the measurement processing;

FIGS. 12A to 12C are views each showing a message screen; and

FIGS. 13A and 13B are flowcharts for explaining the procedure of the measurement processing.

### DESCRIPTION OF THE EMBODIMENTS

Hereinafter, embodiments will be described in detail with reference to the attached drawings. Note, the following embodiments are not intended to limit the scope of the present disclosure. Multiple features are described in the embodiments, but limitation is not made the disclosure that requires all such features, and multiple such features may be combined as appropriate. Furthermore, in the attached drawings, the same reference numerals are given to the same or similar configurations, and redundant description thereof is omitted.

Depending on the configuration of a color validation system, it is assumed that connection of a measurement device is switched among a plurality of color validation servers. Along with switching, measurement processing may be interrupted, and it is necessary to re-initialize a measurement apparatus to resume the measurement processing, thus degrading convenience.

According to the present disclosure, it is possible to improve convenience in resuming measurement processing.

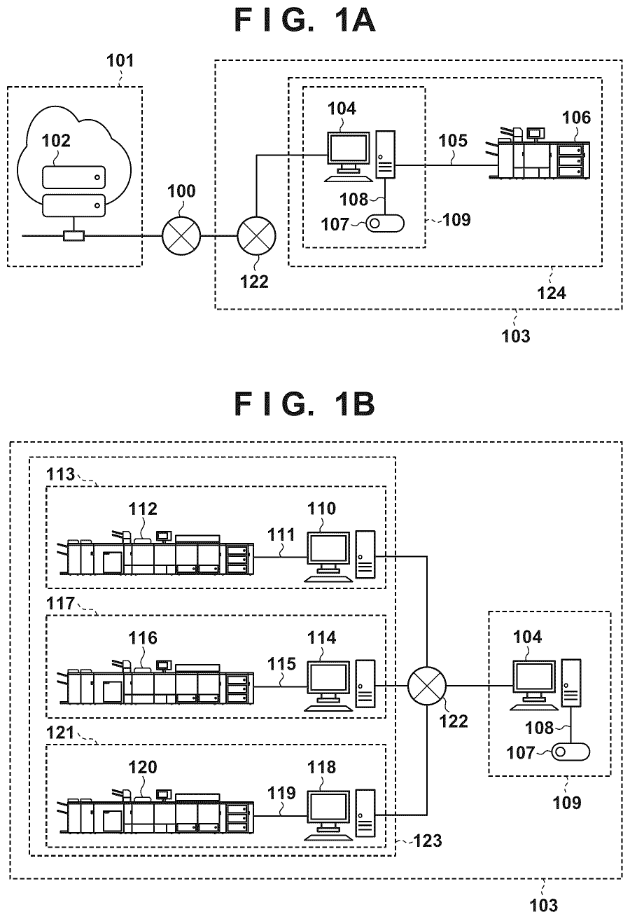

FIG. 1B is a view showing an example of the configuration of a color validation system according to this embodiment. FIG. 1A will be described later. In commercial printing, there exists a large-scale image forming apparatus that prints on a roll sheet or prints on an A1 sheet. FIG. 1B shows an example of such configuration, and shows an example of a configuration including an image forming apparatus and a digital frontend that manages and controls the image forming apparatus. In the configuration shown in FIG. 1B, for example, a system 113 and a client apparatus 104 are located at positions physically separated from each other, and a color validation application is executed on a digital frontend 110 of the system 113. In a user environment in which a plurality of image forming apparatuses and a plurality of digital frontend servers are operated, as shown in FIG. 1B, assume that there exist a plurality of Web servers, each Web server has an independent environment, and these are used in parallel.

The Web server provides a Web application (for example, a color validation application). In this case, the software of the Web server is formed by including a frontend that controls display of the Web browser on the client apparatus or the like, and a backend. The frontend manages/holds a program (JavaScript) to be executed on the Web browser. For example, when the program is transmitted (downloaded) to the client apparatus, the Web browser on the client apparatus performs corresponding display. The frontend includes, for example, a program for performing user authentication and a program for performing content creation/editing processing. Note that in a state in which the program of the frontend has been downloaded on the client apparatus, this program becomes a part of the software configuration of the client apparatus.

A color validation system 103 shown in FIG. 1B is configured to operate the color validation application on the server apparatus 110 and server apparatuses 114 and 118 in a local intra network 122 (to be referred to as a network hereinafter) in a company. The server apparatuses 110, 114, and 118 and a color validation local system 109 (to be referred to as a local system hereinafter) are connected via the network 122. In the local system 109, the user can operate the Web browser on the client apparatus 104. Then, the user operates a measurement device 107 connected to the client apparatus 104 to perform measurement processing in cooperation with each of the server apparatuses 110, 114, and 118. Each of the server apparatuses 110, 114, and 118 is a color validation server in the color validation system.

Each of the server apparatuses 110, 114, and 118 is an information processing apparatus called a digital frontend corresponding to each of image forming apparatuses 112, 116, and 120. Each of the server apparatuses 110, 114, and 118 controls printing of each of the image forming apparatuses 112, 116, and 120, and also operates as a color validation server. Note that FIG. 1B shows an example in which there are the three server apparatuses 110, 114, and 118. In a case where there are a plurality of color validation servers, a client application that corresponds to the number of servers is necessary. In the client apparatus that uses the Web browser, a plurality of Web browsers may be operated in parallel. By switching the connection setting to the server apparatus of the measurement device 107 and causing the system to re-recognize it, the measurement device 107 can be shared among the plurality of server apparatuses. The local system 109 is an example of a configuration in which the measurement device 107 is shared among the plurality of server apparatuses. The color validation system shown in FIG. 1B is a system in which the server apparatus and the client apparatus perform color validation in cooperation with each other and in which there exists a corresponding server apparatus for each image forming apparatus. Therefore, it can be unnecessary to set designation of an image forming apparatus for the color validation application.

The color validation process performed in the color validation system includes the following three steps.
(1) A step in which the image forming apparatus prints a chart formed by a plurality of color patches
(2) A step of measuring the chart
(3) A step of inspecting “passed/failed” by comparing the measurement result of the chart with a color reference

Note that the color reference may be the color reference of the printing industry or a color reference independently defined by a printing company.

A Web page displayed on the Web browser in the color validation process is formed by content (host content) acquired from the Web server. That is, the measurement processing is mainly controlled by the Web server, and the overall control (display, communication with the measurement device, transmission/reception of the measurement result, and the like) of the measurement processing is performed by an instruction by the host content.

On the other hand, in measurement of the chart, to reflect the measurement result acquired by the measurement on the Web page, content (guest content) acquired from an on-premise application operating on the client apparatus connected to the measurement device 107 is displayed in a nested structure in the host content. At this time, the measurement result displayed as the guest content is not shared with the Web server but displayed on the client apparatus. “On-premise” indicates operation control in the information processing apparatus (client apparatus) that is actually managed/operated by the user in a so-called internal local environment. The on-premise application is an application program that is executed in the information processing apparatus that is managed/operated by the user. The measurement result is transmitted from the client apparatus 104 to the Web server after end of the measurement by an instruction of the Web server. The Web server corresponds to each of the server apparatuses 110, 114, and 118.

In the step of measuring the chart, connection may be disconnected from the Web server, for example, the Web page may erroneously be closed during measurement by the measurement device. At the time of reconnection, it is necessary to re-initialize the measurement device and redo the measurement processing. In the configuration shown in FIG. 1B, when switching the application of the server apparatus to which the client apparatus is connected, reconnection and re-initialization of the measurement device may similarly be performed. In this case as well, it is necessary to perform the measurement processing from the beginning, and the procedure of reconnection of the measurement device is not easy. Therefore, at the time of reconnection of the measurement device, it is desirable to resume the measurement from the state at the time of the previous disconnection, and it is desired to minimize a user load when switching the server apparatus from the client apparatus.

On the client apparatus 104 on the intra network in the company, a client for the Web server operates. Then, the measurement device 107 is connected by a serial bus 108, and the user operates the measurement device 107, thereby advancing the measurement processing. Note that the connection method may be an interface of another form, instead of the serial bus.

Each of the server apparatuses 110, 114, and 118 serves as a digital frontend to each image forming apparatus. Each of the server apparatuses 110, 114, and 118 controls the image forming apparatus for generating a commercial product, and also operates as a color validation server.

Referring to FIG. 1B, apparatuses connected and installed at positions physically close to each other are surrounded by a dotted-line frame. For example, the systems 109, 113, 117, and 121 exist in different rooms, and are communicably connected by a network. Although not shown, an information processing apparatus for performing a plurality of paperwork processes, an image forming apparatus for general office use, a file server, a server for office work, and the like may be connected to the network 122.

In the system 113, the server apparatus 110 as the digital frontend and the image forming apparatus 112 are connected by a dedicated connection line 111. In the system 117, the server apparatus 114 as the digital frontend and the image forming apparatus 116 are connected by a dedicated connection line 115. In the system 121, the server apparatus 118 as the digital frontend and the image forming apparatus 120 are connected by a dedicated connection line 119. However, general network connection may be used instead of the dedicated line connection. In this case, the image forming apparatuses 112, 116, and 120 are connected to the network 122, and are controlled by the programs operating on the server apparatuses 110, 114, and 118, respectively.

Print settings and print data received from the client apparatus 104 or an information processing apparatus group (not shown) are processed by each of the server apparatuses 110, 114, and 118 as the digital frontend or each of the image forming apparatuses 112, 116, and 120. Then, each of the image forming apparatuses 112, 116, and 120 produces a print product. In an environment in which there are a plurality of image forming apparatuses, as shown in FIG. 1B, the measurement device 107 may be shared, and in this case, the measurement device 107 is shared among a plurality of color validation servers to perform measurement processing.

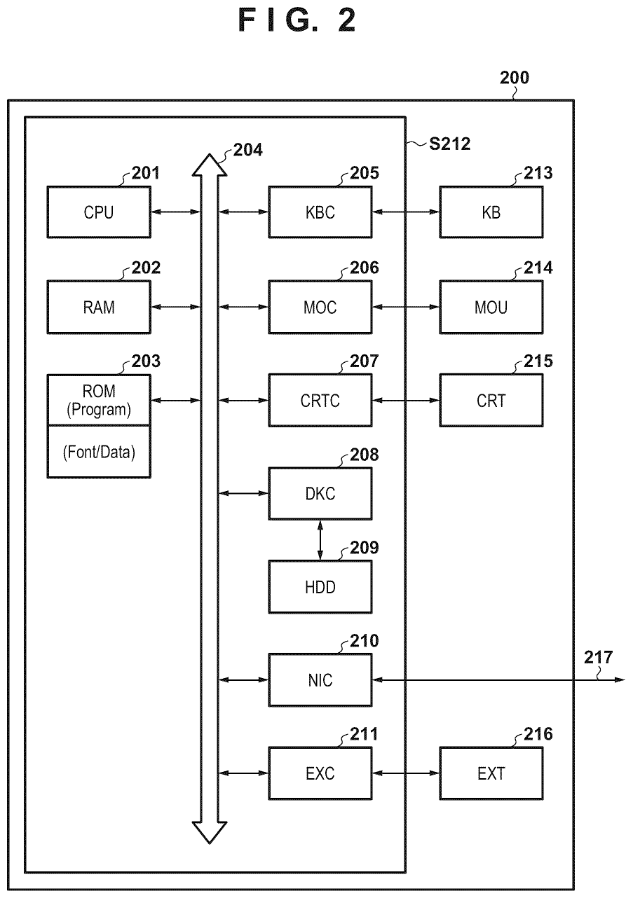

FIG. 2 is a block diagram showing the configuration of the information processing apparatus. The configuration shown in FIG. 2 is an example of the configuration of each of the client apparatus 104 and the server apparatuses 110, 114, and 118. A CPU 201 is a central processing unit for controlling the functions of various blocks connected to a bus 204, and control signals and data for the control processing are transmitted between the blocks on the bus 204. The CPU 201 reads out a program stored and arranged in a program area on a RAM 202 or a ROM 203 and executes it. An application program is loaded from the ROM 203 or an HDD 209 to the RAM 202 by an operating system that performs overall control of the information processing apparatus, and executed by the CPU 201. The operation of an information processing apparatus 200 according to this embodiment is implemented when, for example, the CPU 201 reads out a program stored in the ROM 203 to the RAM 202 and executes it. The ROM 203 is formed from, for example, a font ROM/data ROM in addition to a program ROM. The RAM 202 stores a program arranged, and also functions as an auxiliary memory such as the main memory, work area, or the like of the CPU 201.

A keyboard controller (KBC) 205 controls key input from a keyboard (KB) 213 connected to the apparatus. A mouse controller (MOC) 206 controls input from a mouse pointing device (MOU) 214. A display controller (CRTC) 207 controls display on a display unit (CRT) 215. A disk controller (DKC) 208 controls access (readout and write) to the storage device (HDD) 209. The storage device 209 stores an activation program, an operating system program, various applications, font data, and the like. A network controller (NIC) 210 connects the information processing apparatus 200 to the network. The information processing apparatus 200 executes communication with another apparatus via a network 217.

Note that if the form of the information processing apparatus 200 is a smart device such as a portable terminal, the information processing apparatus 200 may include a touch panel controller or the like instead of the keyboard controller (KBC) 205. Instead of or in addition to the HDD 209, a storage device may be provided or a detachable storage device may be provided. The detailed internal configuration of the network controller (NIC) 210 is different between a case of a wired LAN or a wireless LAN and a case of including both of them. However, in terms of performing communication with an external apparatus, the network controller (NIC) 210 functions as the same block. The difference in internal configuration is hidden inside the network controller (NIC) 210, and the network controller (NIC) 210 is equivalent for other modules shown in FIG. 2.

The information processing apparatus 200 includes an external extension control unit (EXC) 211 used to attach and control an apparatus (EXT) 216 that performs an extension function not included in the above-described components. In this embodiment, the measurement device 107 corresponds to the extension function, and the function is usable in the information processing apparatus 200. Note that the external extension control unit 211 may use a general-purpose standard interface, for example, a USB interface or SCSI interface.

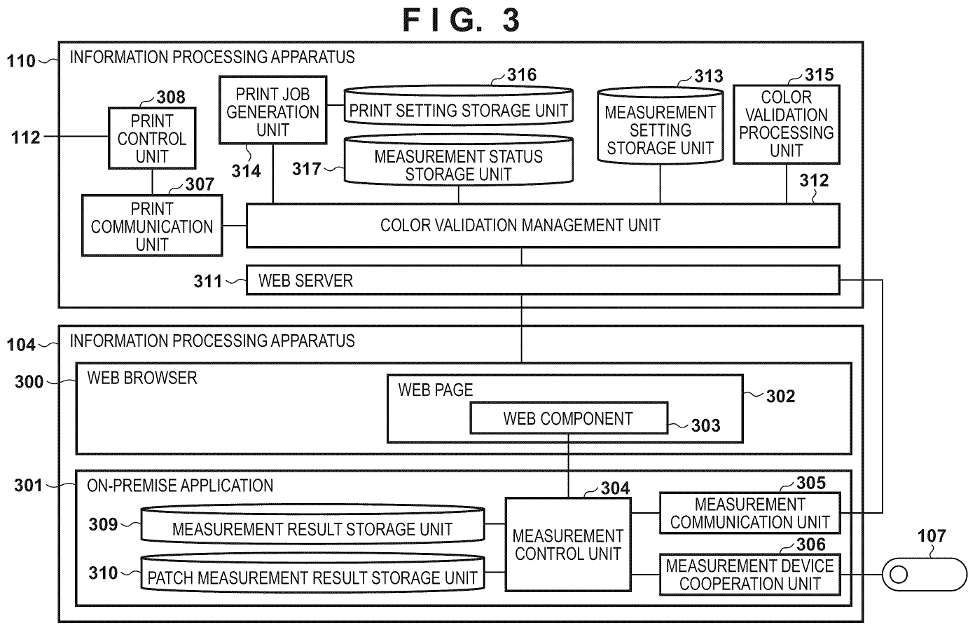

FIG. 3 is a block diagram showing an example of the functional block configuration of the color validation system. The system 113 will be described below as a representative example of the systems 113, 117, and 121. That is, the operations of the server apparatus 110 and the image forming apparatus 112 included in the system 113 can be applied to the apparatuses included in each of the systems 117 and 121.

The functional blocks of the client apparatus 104 of the color validation system 103 will be described.

A Web browser 300 performs a display control operation on the client apparatus 104 and communicates with a Web server 311 of the server apparatus 110, thereby acquiring content described in HTML or the like. Furthermore, the Web browser 300 parses the acquired content, and displays it as a Web page 302. Furthermore, the Web browser 300 can display a received image file, and receive and execute, as a Web component, a script described in a programming language such as JavaScript®.

An on-premise application 301 operating on the client apparatus 104 serves as a proxy function that relays access or assists control among the server apparatus 110, the measurement device 107, and the Web browser 300. For example, when measuring the printed chart, the measurement device 107 is controlled via the on-premise application 301. In other words, the on-premise application 301 has a measurement device control function. Note that in the configuration shown in FIG. 1B, the server apparatus 110 directly transmits the print settings and the print data of the chart to the image forming apparatus 112 without relaying the on-premise application 301.

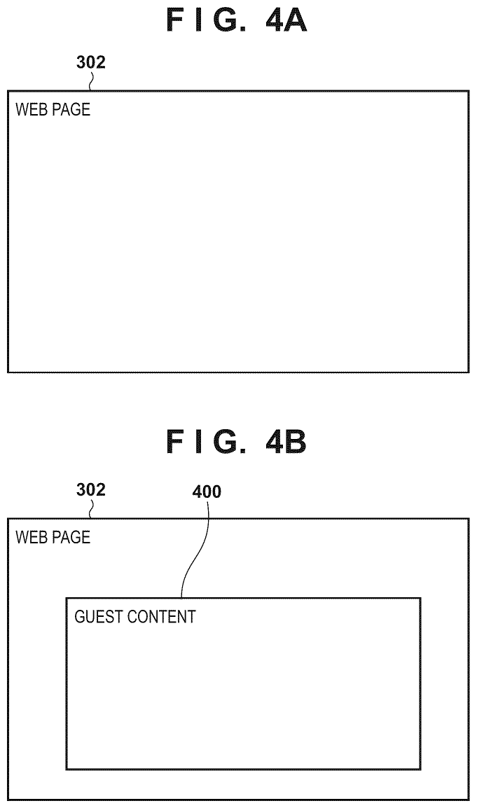

The Web page 302 is displayed by designating a URL. Web content specified by the URL is acquired in communication with the server apparatus specified by the URL, and the Web browser 300 interprets the content and displays the Web page 302. The Web page 302 may be formed by a single piece of content, as shown in FIG. 4A, or may be displayed while guest content 400 is nested, as shown in FIG. 4B. In this embodiment, for example, a chart preview is displayed as the guest content 400.

A Web component 303 is a program linked with the Web page 302, and is executed on the Web browser 300. In this embodiment, the Web component 303 is assumed to be in JavaScript® but need only be a program operating on the Web browser 300. For example, the Web component 303 may be an applet, ActiveX, a plug-in program of the Web browser 300, a library, or the like. When the Web browser 300 designates a service for measurement by, for example, a URL, the Web component 303 is downloaded as Web content or a part of it from the designated URL, and is displayed as a result.

When the Web browser 300 displays the Web page 302, the Web component 303 accesses a measurement control unit 304 and establishes communication for controlling the measurement device 107. After that, the Web component 303 sends an interaction instruction to the measurement control unit 304 in response to a user operation on the Web page 302. Then, the measurement control unit 304 performs, for the measurement device 107, data input control or response control corresponding to the user operation. The Web component 303 receives, from the measurement control unit 304, a response of the measurement device 107 to the above instruction, and reflects it on the Web page 302. More specifically, for example, the progress of the measurement processing is displayed. Note that communication between the Web component 303 and the measurement control unit 304 is implemented by, for example, the WebSocket function. This function allows the Web component 303 and the measurement control unit 304 to always maintain connection via a specific network port, thereby enabling communication by bidirectional requests. Thus, it is possible to transmit input by the user operation to the measurement device 107 in real time, and to reflect the response of the measurement device 107 on the Web page 302 in real time.

The measurement control unit 304 receives an instruction from the Web component 303, and controls the measurement device 107 via a measurement device cooperation unit 306. When the measurement device 107 reads a patch for measurement scanning, the measurement control unit 304 transmits a flag of a read result and identification information to the Web component 303. The measurement control unit 304 stores the read data of the patch in a patch measurement result storage unit 310. After end of reading of all patches forming a test chart (to be also simply referred to as a chart hereinafter) for color validation (measurement), the measurement control unit 304 stores the read result (the measurement result of the chart) in a measurement result storage unit 309. The patch is read when, for example, the user operates the measurement device 107 for each patch. Furthermore, upon receiving a measurement finish instruction from the Web component 303, the measurement control unit 304 acquires a measurement result matching identification information included in the measurement finish instruction from the measurement result storage unit 309, and transmits it to the Web server 311 via a measurement communication unit 305. Note that the identification information is information for identifying measurement processing corresponding to each color reference.

The measurement communication unit 305 performs communication between the measurement control unit 304 and the Web server 311. Upon receiving the measurement result from the measurement control unit 304, the measurement communication unit 305 starts communication with the Web server 311, and transmits the measurement result matching the identification information included in the measurement finish instruction to the Web server 311. Communication between the measurement communication unit 305 and the Web server 311 is performed by, for example, HTTP. Note that the Web server 311 and the on-premise application 301 need not always be connected in real time. The measurement device cooperation unit 306 is an interface with the measurement device 107, and mediates exchange between the measurement control unit 304 and the measurement device 107.

After end of reading of all the patches forming the chart, the measurement control unit 304 stores the measurement result of the chart in the measurement result storage unit 309. The measurement result storage unit 309 may store the measurement result as a file in the HDD 209 of the client apparatus 104 or may form a database in a table format. The patch measurement result storage unit 310 is an area that stores the patch measurement result in case where the connection between the Web browser 300 and the Web server 311 is disconnected or switched during the measurement of the chart. The patch measurement result storage unit 310 may store the measurement result as a file in the HDD 209 of the client apparatus 104, or may form a database in a table format.

Next, the functional blocks of the server apparatus 110 of the color validation system 103 will be described.

The Web server 311 is a program that performs HTTP communication with the Web browser 300 and provides display of HTML or an object (image, program, or the like) to the Web browser 300. The Web server 311 performs communication such as HTTP communication with the measurement communication unit 305, and receives the measurement result of the chart from the measurement control unit 304.

A color validation management unit 312 is a function of controlling execution of each process of the color validation process, and corresponds to the color validation application. Based on a user instruction input on the Web page 302, the color validation management unit 312 controls to execute print processing, measurement processing, and color validation processing of the chart. Furthermore, the color validation management unit 312 controls to store the measurement result received by the Web server 311 in a measurement status storage unit 317.

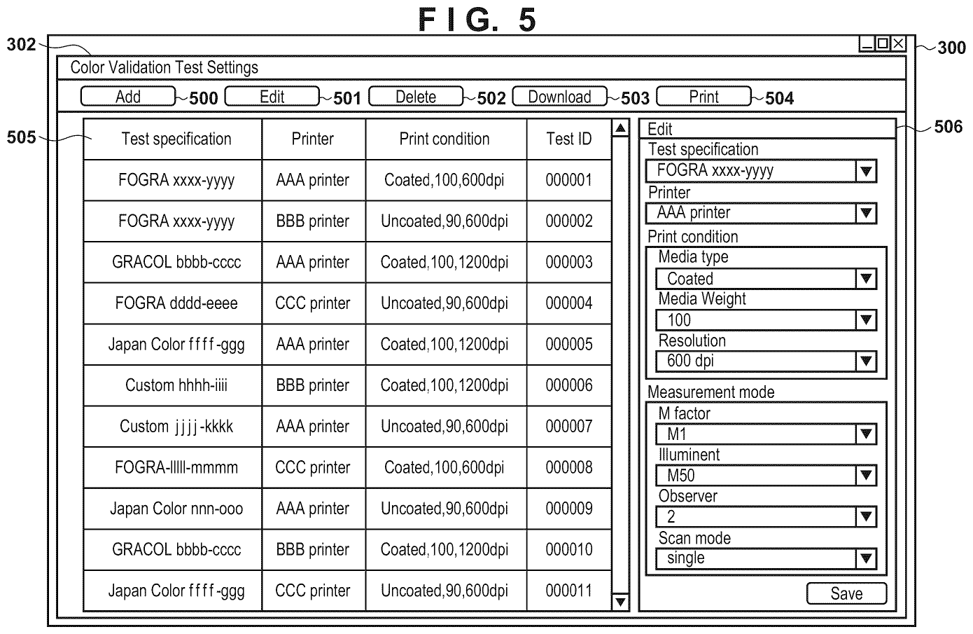

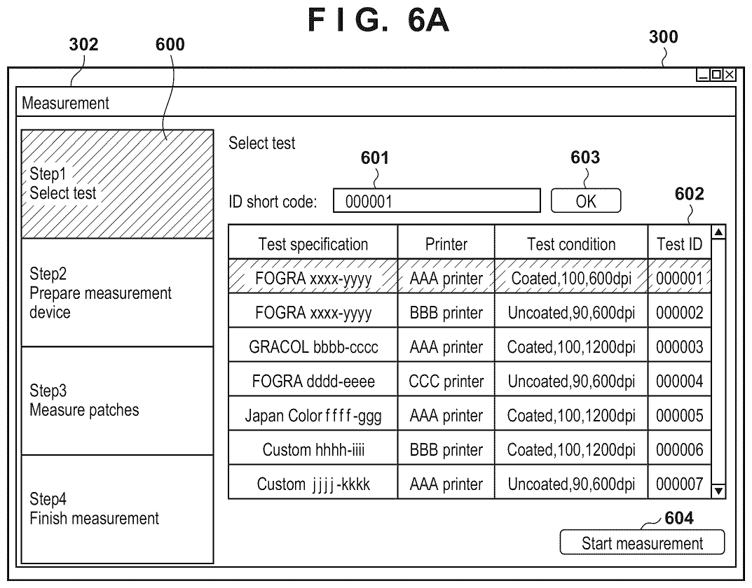

A measurement setting storage unit 313 is a portion where measurement settings input by the user are stored. When the user inputs the measurement settings on the Web page 302, information of the measurement settings is transmitted from the Web component 303 to the Web server 311 via the Web browser 300. FIG. 5 is a view showing an example of a measurement setting screen, and will be described later. The Web server 311 transfers the received measurement settings to the color validation management unit 312. Upon receiving the measurement settings, the color validation management unit 312 stores the measurement settings in the measurement setting storage unit 313.

The measurement settings stored in the measurement setting storage unit 313 are used for various applications in the color validation system. In this embodiment, the measurement settings are input by the user, and print settings and print data are generated based on the measurement settings. The measurement settings are also used as a determination criterion of the measurement result in color validation.

The measurement setting storage unit 313 stores the measurement result transmitted from the on-premise application 301 in linkage with the measurement settings having the same identification information. Then, based on the identification information, the measurement setting storage unit 313 stores the color validation result of a color validation processing unit 315 in linkage with the measurement settings. For example, the measurement settings and the measurement result are linked with identification information “000001” or “000002” in FIG. 5. The identification information is generated by the client apparatus 104, and transmitted to the color validation management unit 312 of the server apparatus 110. Thus, the identification information is shared between the server apparatus 110 and the client apparatus 104.

A print job generation unit 314 has a function of generating print settings and print data. More specifically, for example, when a print instruction is accepted from the user on the Web page 302, the Web component 303 transmits the print instruction to the Web server 311 via the Web browser 300. The print instruction includes a command and identification information for identifying measurement processing. When the Web server 311 transfers the print instruction to the color validation management unit 312, the color validation management unit 312 acquires, from the measurement setting storage unit 313, the measurement settings based on the identification information (for example, “000001”) designated by the print instruction.

The color validation management unit 312 transfers the acquired measurement settings to the print job generation unit 314. The print job generation unit 314 generates a print job that can execute the received measurement settings and includes the print settings and the print data of the chart. A print setting storage unit 316 links the color reference and print parameters with each other in advance with respect to generation of print settings. Based on the color reference (for example “FOGRA xxxx-yyyy”) of the measurement settings, the print job generation unit 314 acquires the related print parameters from the print setting storage unit 316, and generates print settings.

Then, the print job generation unit 314 returns the generated print job to the color validation management unit 312. After that, the color validation management unit 312 transfers the print job including the print settings and the print data to a print communication unit 307. The print communication unit 307 receives the print job, and transfers it to a print control unit 308. At this time, the print communication unit 307 may transfer the IP address of the image forming apparatus 112 to the print control unit 308. Upon receiving the print job from the print communication unit 307, the print control unit 308 transmits the print job to the image forming apparatus 112. A method of transmitting the print job is not particularly limited, and for example, a method such as an LPR protocol or a hot folder may be used. In addition to the print job, data (PJL data or the like) for managing and controlling the image forming apparatus 112 may be transmitted.

The color validation processing unit 315 determines “passed/failed” with respect to a designated color reference by comparing the measurement result obtained by reading the printed chart with the color reference of the printing industry or the color reference independently defined by a printing company. More specifically, for example, when the user presses a finish measurement button on the Web page 302, the Web component 303 sends, to the measurement control unit 304, a transmission instruction to transmit the measurement result. The transmission instruction includes a command and identification information. Upon receiving the transmission instruction, the measurement control unit 304 acquires the measurement result stored in the measurement result storage unit 309 based on the identification information (for example, “000001”) included in the transmission instruction, and transmits the measurement result to the Web server 311 via the measurement communication unit 305. Then, after storing the measurement result in the measurement setting storage unit 313, the color validation management unit 312 acquires the measurement settings associated with the measurement result from the measurement setting storage unit 313 and transfers them to the color validation processing unit 315. The color validation processing unit 315 executes color validation based on the measurement settings and the measurement result, and returns a determination result to the color validation management unit 312. Then, the color validation management unit 312 stores the determination result in the measurement setting storage unit 313.

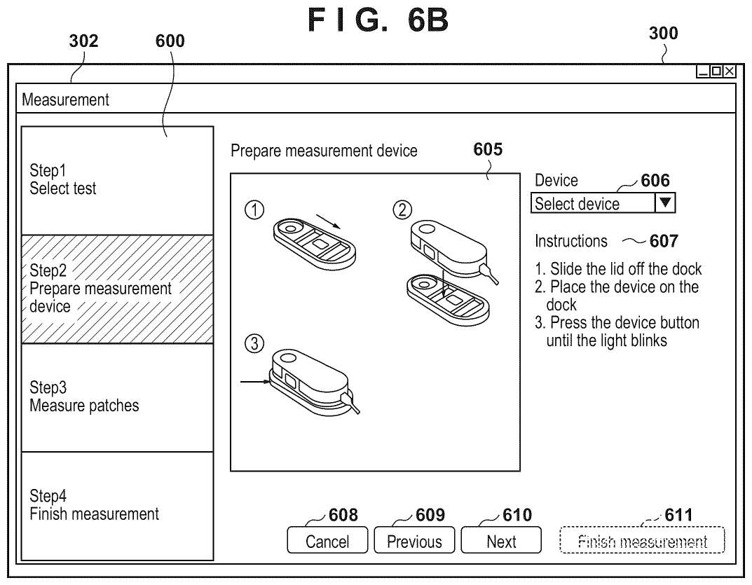

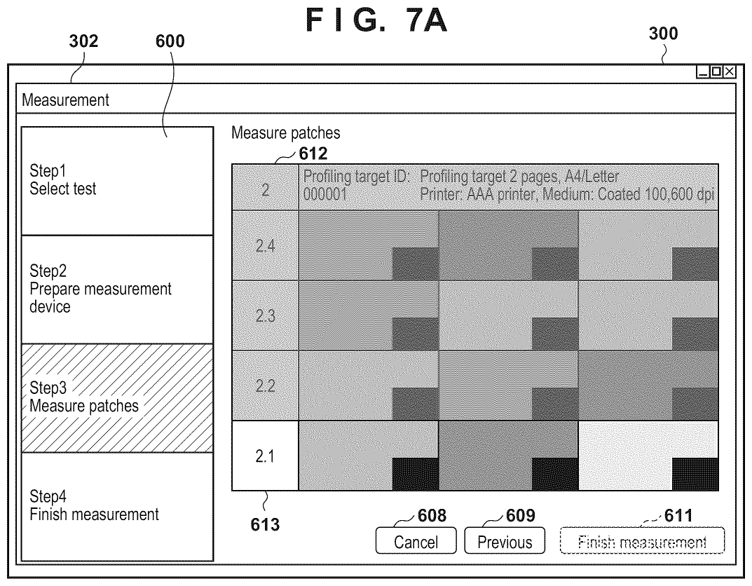

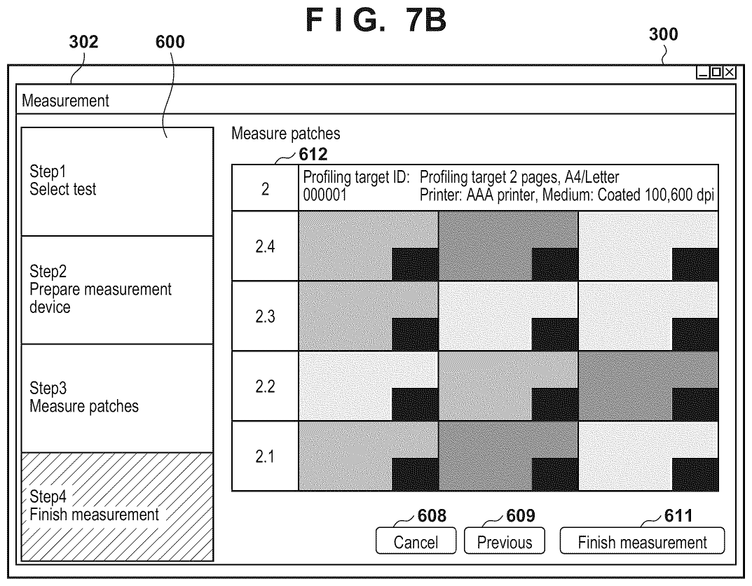

The measurement status storage unit 317 stores the identification information of the measurement processing during measurement in the client apparatus 104. More specifically, for example, when the user presses a “next” button to advance to control of operating the scan processing of the measurement device on a screen shown in FIG. 6B to be described later, a Web page of patch measurement is transmitted from the Web server 311 to the Web browser 300. At this timing, the color validation management unit 312 stores identification information as information representing a measurement status in the measurement status storage unit 317. Furthermore, at a timing when the user presses a “finish measurement button” 611, on a screen shown in FIG. 7B to be described later, to instruct that the scan processing of the measurement device has finished, and transmission of the measurement result from the on-premise application 301 to the color validation management unit 312 finishes, the color validation management unit 312 erases the identification information from the measurement status storage unit 317.

The color validation management unit 312 determines whether to perform restoration processing of the patch measurement result based on the information stored in the measurement status storage unit 317 at the time of next connection in a case where the connection between the Web server 311 and the Web browser 300 is disconnected (which includes instantaneous disconnection and connection switching) during the measurement of the chart. Note that disconnection includes instantaneous disconnection and disconnection along with switching of the connection. In this embodiment, the restoration processing includes redisplay of the stored patch measurement result. Determination of whether to perform restoration processing will be described later. In this embodiment, during the measurement, the measurement processing interrupted or set in a waiting state due to the above disconnection will be referred to as “measurement in progress” hereinafter. In particular, the measurement processing interrupted during measurement will sometimes be referred to as “measurement in progress”, “interrupted measurement processing”, or “switched measurement processing” hereinafter.

The color validation management unit 312 may control to link address information (for example, an IP address) of a connection destination (client apparatus) to which the Web page 302 has been transmitted. More specifically, for example, the color validation management unit 312 stores information representing a measurement status in the measurement status storage unit 317 based on the IP address. In a case where there are a plurality of client apparatuses, it is possible to store information representing the status of the measurement of the chart that was executed at the time of disconnecting the connection of each client apparatus, by linking the address information of each client apparatus.

If the connection between the Web server 311 and the Web browser 300 is disconnected, the measurement communication unit 305 of the on-premise application 301 links, with information of the measurement in progress, the address information (for example, a URL) of the server apparatus that transmits the Web page 302. In a case where there are a plurality of server apparatuses, it is possible to store information representing the status of the measurement of the chart that was executed at the time of switching the connection to each server apparatus, by linking the address information of each server apparatus.

FIG. 5 is a view showing an example of the measurement setting screen of the Web page 302 displayed on the Web browser 300. In a measurement setting list 505, created measurement settings are displayed. In this embodiment, the color reference used in color validation, the image forming apparatus as a color validation target, the print condition of the chart, and the identification information are displayed in the measurement setting list 505.

The measurement setting list includes a button 500 for adding measurement settings to the measurement setting list 505, a button 501 for selecting measurement settings from the measurement setting list 505 and editing them, a button 502 for deleting measurement settings from the measurement setting list 505, a button 503 for downloading measurement settings, and a button 504 for accepting an instruction to execute printing of the chart. Each editing button in an editing region 506 becomes active when the button 501 is pressed. For example, a selection button of each measurement processing, a selection button of an image forming apparatus, a button for selecting a sheet type/weight/resolution as a print condition, and a selection button of M factor/brightness/scan mode as a measurement mode are displayed as active. Measurement settings are input by a user operation on the measurement setting screen shown in FIG. 5.

FIGS. 6A, 6B, 7A, and 7B are views showing an example of a measurement execution screen of the Web page 302 displayed on the Web browser 300. The measurement execution screen is formed from screens of four steps respectively corresponding to FIGS. 6A, 6B, 7A, and 7B. The four steps include selection of measurement settings, preparation of a measurement device, measurement of the chart, and end of the measurement of the chart.

FIG. 6A shows a measurement setting selection screen. A measurement step display region 600 visually displays which of the four steps of the measurement operation is currently performed. Identification information of the measurement processing is input to an identification information input box 601, and selection of measurement processing matching the identification information is confirmed by pressing an OK button 603. Note that the measurement processing is processing that can be identified by the measurement settings. In other words, the measurement processing corresponds to the measurement settings. A start measurement button 604 is used to start the measurement processing selected in a measurement setting list 602.

FIG. 6B shows a preview screen of a measurement device preparation operation, and a preview 605 serves to show the preparation operation of the measurement device 107 using an image to be easily understood. In this embodiment, a still preview image is displayed. A measurement device selection region 606 is a region where a list of measurement devices connected to the client apparatus 104 is displayed so that the user selects one measurement device. Measurement device preparation operation information 607 displays the preparation operation of the measurement device selected in the measurement device selection region 606. If the preparation operation is different for each measurement device, text displayed in the measurement device preparation operation information 607 is changed every time selection is made. A measurement cancel button 608 is used to cancel the currently performed measurement processing. When the measurement cancel button 608 is pressed, the measurement processing is canceled, and control returns to the measurement setting selection screen shown in FIG. 6A. A previous button 609 is used to return to the screen immediately before the currently displayed screen. A next button 610 is used to advance to a screen immediately after the currently displayed screen.

FIG. 7A shows a chart measurement screen. In a chart preview 612 on the chart measurement screen shown in FIG. 7A, each of patches having undergone measurement is displayed in color corresponding to a measurement value. A patch not having undergone measurement is displayed in, for example, gray so as to be visually perceived. Thus, the progress of the measurement processing is displayed, and the user can immediately grasp the progress of the measurement processing from the screen. The finish measurement button 611 is used to finish the measurement processing, and display of the finish measurement button 611 is controlled to be inoperable at the time of FIG. 7A.

FIG. 7B shows a chart measurement screen on which the finish measurement button 611 is enabled. As shown in FIG. 7B, the finish measurement button 611 is enabled when measurement for all the patches of the chart ends. At this time, in the measurement step display region 600, step 4 is displayed. When the enabled finish measurement button 611 is pressed, the measurement of the chart finishes. Then, the Web component 303 instructs the measurement control unit 304 to transmit the measurement result to the Web server 311.

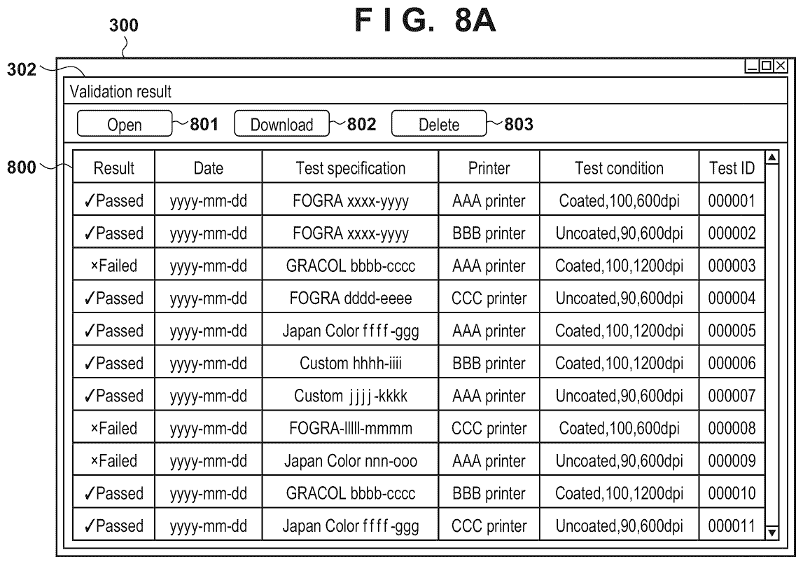

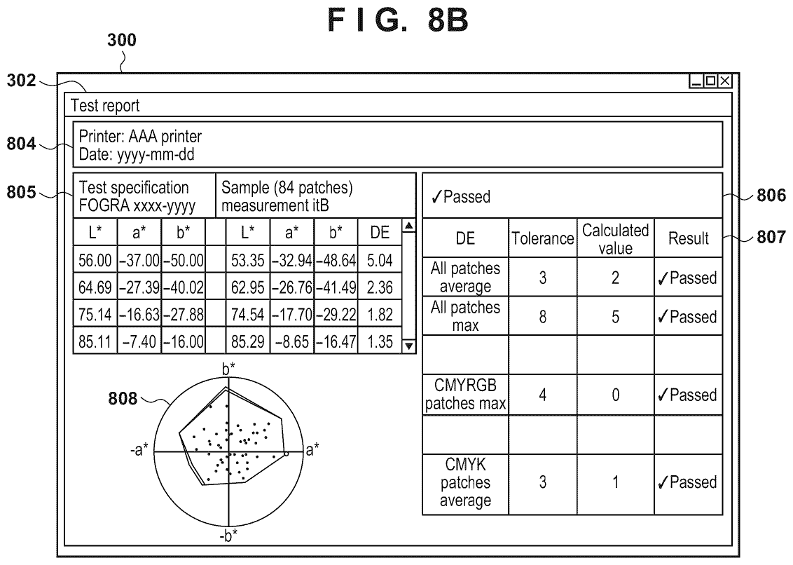

FIGS. 8A and 8B are views each showing an example of a screen indicating a color validation result, which is displayed after end of measurement. FIG. 8A shows a color validation result list screen. A color validation result list 800 is a region where the result of executed color validation is displayed. Color validation is, for example, processing of comparing the measurement value of each patch of a printed test chart with the reference value of each patch, and determining “passed” if the color difference falls within an allowable range and determining “failed” otherwise. The color validation result indicates the validation result. More specifically, for example, the color validation result (Passed or Failed) is displayed in a Result column. A color validation result display button 801 is a button used to display a color validation report to be described later with reference to FIG. 8B. A color validation result download button 802 is a button used to download the color validation report to a local folder. A color validation result delete button 803 is a button used to delete the color validation result selected in the color validation result list 800.

FIG. 8B shows an example of the color validation report in which details of the color validation result are described. An apparatus/date 804 is a region where the image forming apparatus used for color validation and the date of execution of color validation are displayed. In a measurement value 805, a result of comparing information of the color reference designated in the measurement settings by the user and a comparison result with the value of the measurement result is displayed, and practical LAB values are displayed. An overall determination result 806 displays the passed/failed determination result of the color validation result. An item-specific determination result 807 displays a passed/failed determination result for each individual check item of color validation. A color difference graph 808 graphically displays the color difference between the color reference selected by the user and the measurement result of actually measuring the chart.

The configuration of the color validation system according to this embodiment has been described. The configuration implements three steps of the color validation process, that is, printing of the chart, measurement of the chart, and color validation.

The procedure of the measurement processing performed by the cooperative operation of the server apparatus 110 and the client apparatus 104, which is to be the premise of processing according to this embodiment, will now be described. Note that the measurement processing is processing included in the color validation process (color validation processing), as described above.

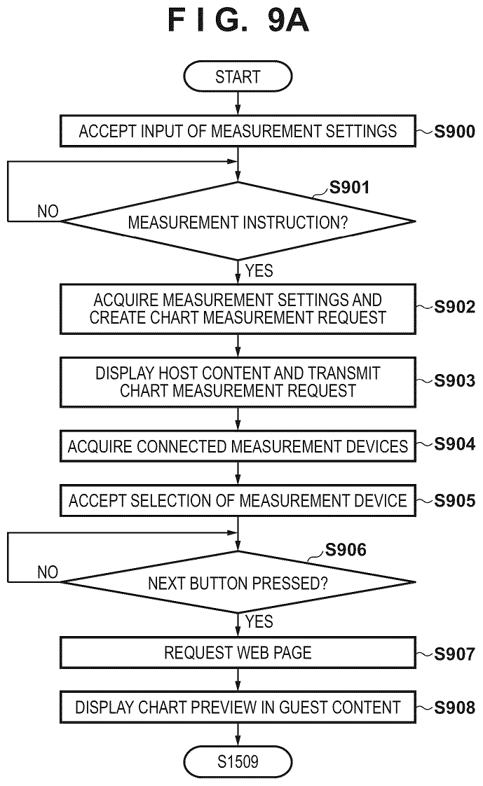

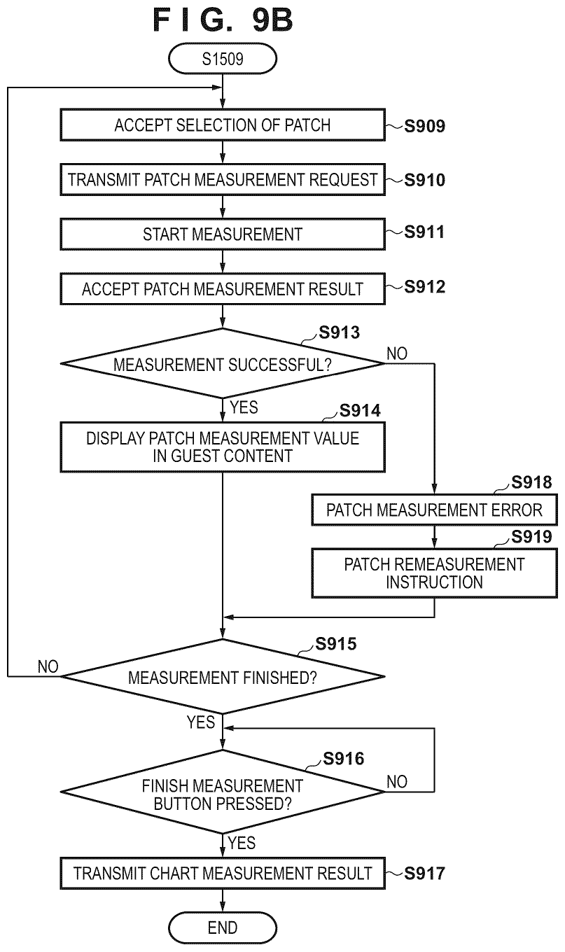

FIGS. 9A and 9B are flowcharts for explaining the procedure of the measurement processing. The following processing is implemented when the CPU 201 of each of the server apparatus 110 and the client apparatus 104 reads out a program stored in the ROM 203 to the RAM 202 and executes it. The processing shown in FIG. 9A is started in a case where the measurement setting selection screen shown in FIG. 6A is displayed.

In step S900 of FIG. 9A, the color validation management unit 312 stands by for acceptance of a measurement start instruction from the user on the measurement setting selection screen shown in FIG. 6A. In step S901, the color validation management unit 312 determines whether the measurement start instruction has been accepted. If it is determined that the measurement start instruction has been accepted, the process advances to step S902. If it is determined that the measurement start instruction has not been accepted, the processing in step S901 is repeated.

In step S902, the color validation management unit 312 acquires the measurement settings based on identification information (for example, “000001”) designated by the measurement start instruction from the measurement setting storage unit 313, and creates a chart measurement request. Then, the color validation management unit 312 transfers the chart measurement request to the Web server 311 together with the Web page 302 of the measurement device preparation screen shown in FIG. 6B.

In step S903, the Web server 311 transmits the Web page 302 to the Web browser 300. The Web browser 300 displays the Web page 302 received from the Web server 311. At this time, the Web server 311 transmits the chart measurement request to the Web browser 300 together with the Web page 302. Note that the Web browser 300 displays only the host content, as shown in FIG. 4A. More specifically, for example, the measurement device preparation screen shown in FIG. 6B is displayed. The measurement device preparation screen does not change dynamically by operating the measurement device 107, and thus only the host content is displayed.

The Web page 302 transmitted from the Web server 311 includes the Web component 303. When the Web page 302 is displayed by the Web browser 300, the Web component 303 establishes connection to the Web server 311 and the measurement control unit 304 to be able to perform mutual communication. When this connection is established, the Web component 303 transfers the chart measurement request to the measurement control unit 304.

In step S904, the Web component 303 transfers the list of measurement devices managed by the measurement control unit 304 to the Web server 311, and acquires, from the Web server 311, the Web page 302 of the measurement device preparation screen on which the list of measurement devices has been reflected. The list of measurement devices is displayed in the measurement device selection region 606 of the measurement device preparation screen shown in FIG. 6B. In step S905, the Web component 303 accepts selection of the measurement device by the user.

In step S906, the Web component 303 determines whether the next button 610 has been pressed on the measurement device preparation screen. If it is determined that the next button 610 has been pressed, the process advances to step S907. If it is determined that the next button 610 has not been pressed, the processing in step S906 is repeated.

In step S907, the Web component 303 communicates with the Web server 311, and requests the Web page 302 of the chart measurement screen from the Web server 311. Upon receiving the request, the Web server 311 requests the color validation management unit 312 to generate the Web page 302 of the chart measurement screen. The color validation management unit 312 generates the Web page 302 including the host content that displays information necessary for the measurement processing of the printed chart and the guest content that displays the chart preview 612. FIG. 7A shows an example of the chart measurement screen. The color validation management unit 312 generates the chart preview 612 using information such as the number of patch lines and the number of patches defined in a patch layout of the measurement settings, and the signal values of color. The Web server 311 transmits the Web page 302 of the chart measurement screen generated by the color validation management unit 312 to the Web browser 300. Similar to step S903, the Web page 302 includes the Web component 303. However, the Web component is different from that transmitted from the Web server 311 in step S903.

In step S908, the Web browser 300 displays the Web page 302 received in step S907. The chart preview 612 of the chart measurement screen is handled as the guest content. Based on the data from the measurement control unit 304, the Web component 303 updates display of the chart preview 612 and accepts a user operation on the chart preview 612.

In step S909 of FIG. 9B, the Web component 303 accepts patch selection by the user on the chart preview 612. The patch selected by the user is a measurement target patch.

In step S910, the Web component 303 transmits, to the measurement control unit 304, a patch measurement request corresponding to the selected patch. In step S911, when the user performs measurement of the patch using the measurement device 107, the measurement control unit 304 receives a measurement value from the measurement device 107 via the measurement device cooperation unit 306. Then, the measurement control unit 304 creates the measurement result of the patch, and transmits it to the Web component 303. In step S912, the Web component 303 receives the patch measurement result from the measurement control unit 304.

In step S913, the Web component 303 performs determination processing of the measurement result. More specifically, for example, if the measurement result (Result) of the patch measurement result is “true”, the Web component 303 determines that the measurement of the patch has succeeded, and advances to step S914. On the other hand, if the measurement result is “false”, the Web component 303 determines that the measurement of the patch has failed, and advances to step S918.

In step S914, the Web component 303 displays a value corresponding to the measurement value (lab-value) of the patch measurement result in each cell of the patch selected in the chart preview 612, which is the guest content. The measurement value may be displayed by a numerical value or a color corresponding to the measurement value may be displayed. Alternatively, a color corresponding to the measurement value may be displayed for each patch, and when a cursor is superimposed on the color, the measurement value of the patch may be displayed by a numerical value.

In step S915, the Web component 303 determines whether measurement for all the patches on the chart preview 612 has finished. If it is determined that measurement for all the patches has finished, the process advances to step S916. If it is determined that measurement for all the patches has not finished, the process returns to step S909, and selection of the next patch is accepted. This determination processing is performed by comparing the measurement settings with the progress of the measurement. If measurement for all the patch lines described in the chart measurement request has finished, the measurement control unit 304 generates a measurement result, stores it in the measurement result storage unit 309, and then advances to step S916.

In step S916, the Web component 303 determines whether the user has pressed the finish measurement button. If the user has pressed the finish measurement button, the Web component 303 transmits a measurement result transmission instruction to the measurement control unit 304.

In step S917, the measurement control unit 304 acquires the measurement result stored in the measurement result storage unit 309 based on identification information (for example, “000001”) for identifying the measurement processing, which is included in the measurement result transmission instruction, and transmits the measurement result to the Web server 311 via the measurement communication unit 305. When transmitting the measurement result to the Web server 311, the measurement control unit 304 performs authentication using authentication information of the chart measurement request, and after authentication succeeds, transmits the measurement result. The Web server 311 transfers the measurement result to the color validation management unit 312. The color validation management unit 312 stores, in the measurement setting storage unit 313, the measurement result in linkage with the measurement settings having the same identification information (for example, “000001”).

In step S918, the Web component 303 displays a warning message of a patch measurement error on the chart preview 612. In step S919, the Web component 303 displays a patch remeasurement instruction on the chart preview 612.

In chart measurement according to this embodiment, the Web page 302 displayed on the Web browser 300 includes host content and guest content. The host content is transmitted from the Web server 311. On the other hand, display of the guest content is not static, and is dynamically updated by data transmitted from the on-premise application 301.

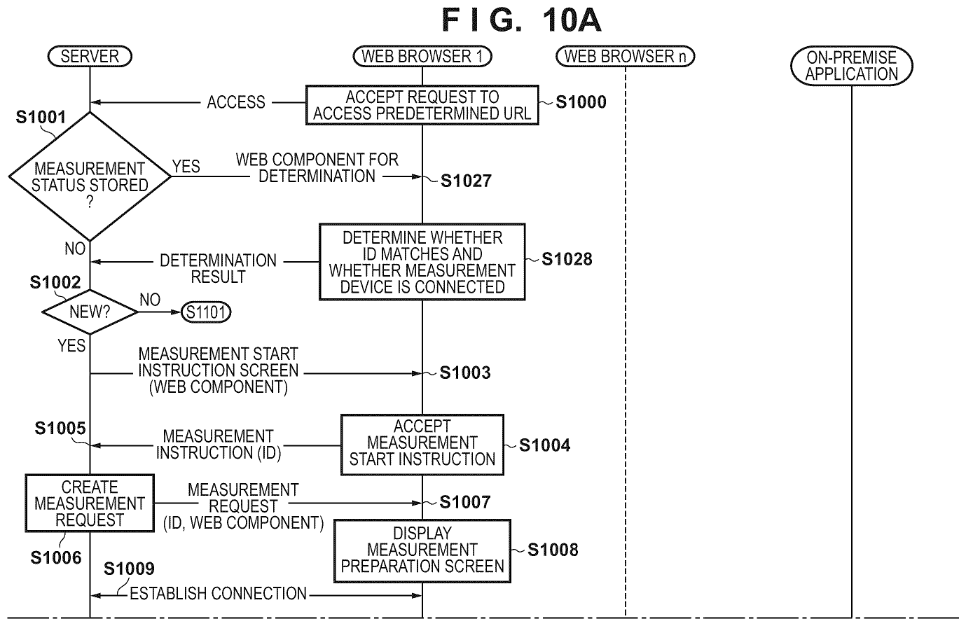

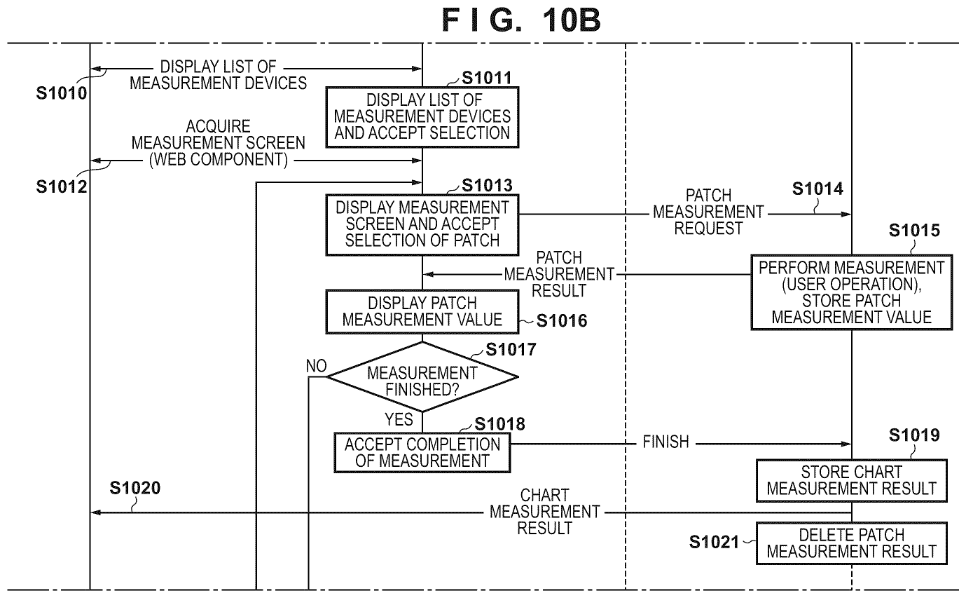

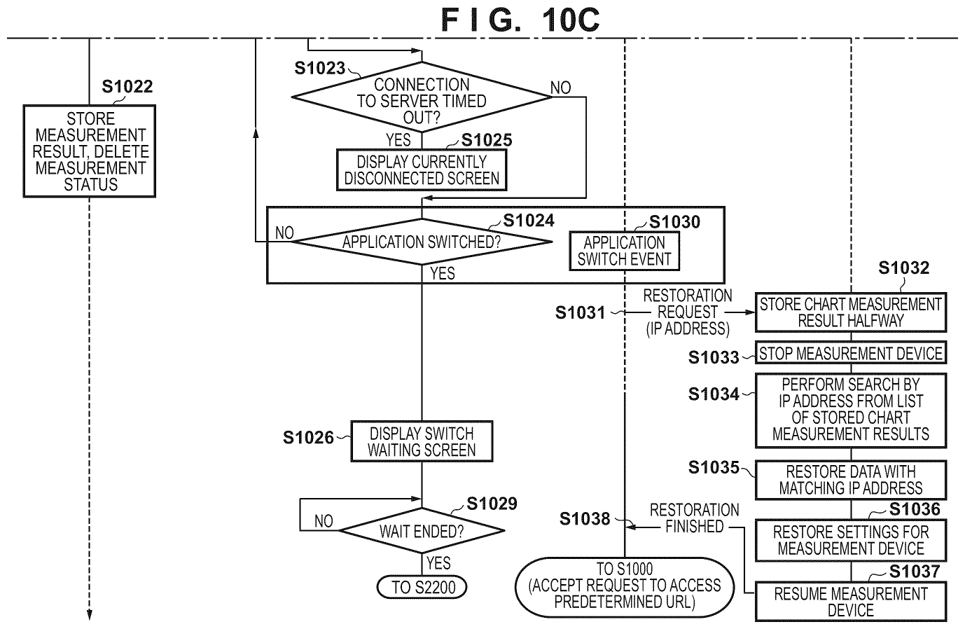

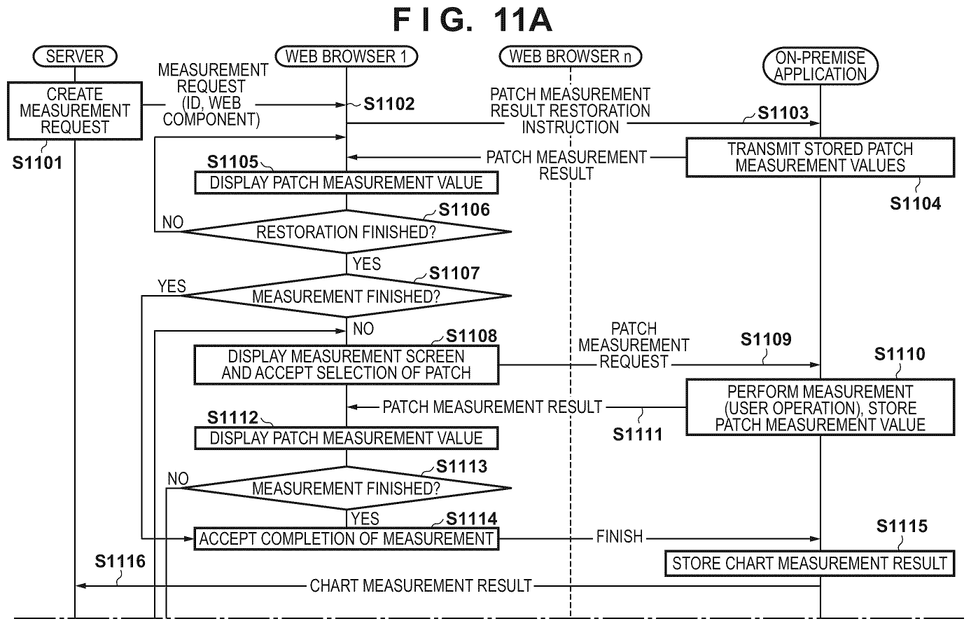

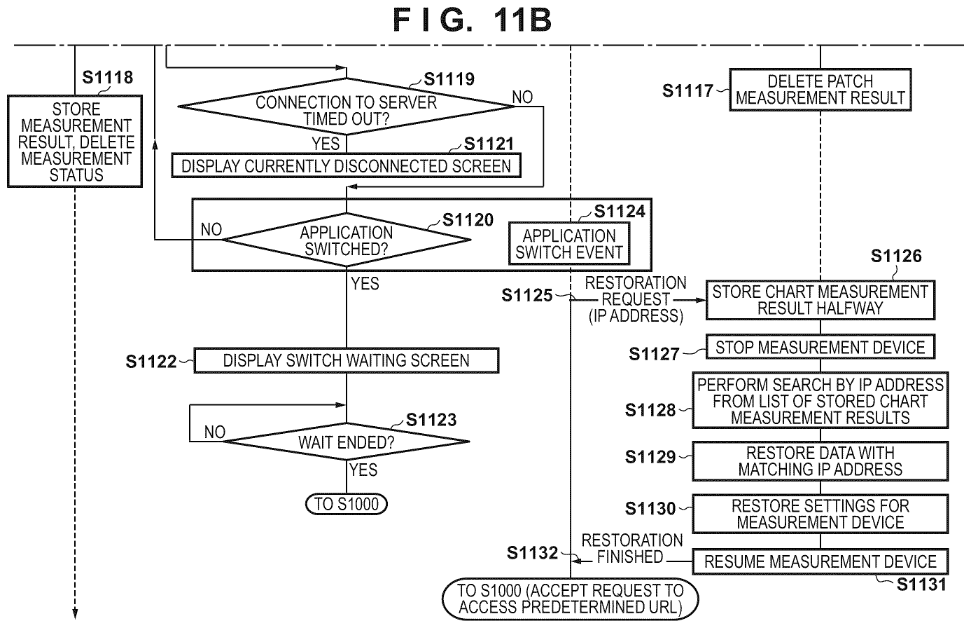

An operation according to this embodiment will be described below with reference to FIGS. 10 and 11. FIGS. 10 and 11 show the sequence of the measurement processing between the server apparatus 110 and the client apparatus 104. The server apparatus 110 will be described as a representative example of the server apparatuses 110, 114, and 118. Each of Web browsers 1 to n in FIGS. 10 and 11 is the Web browser 300 that accesses each server apparatus in the client apparatus 104. Processing by the Web browser 300 shown in FIGS. 10 and 11 includes processing implemented when the Web browser 300 executes the Web component 303. In the description of FIGS. 10 and 11, the Web browser 300 is explained as the Web browser 1 or n.

In S1000, in response to an access request to a predetermined URL by the user, the Web browser 1 accesses the Web server 311 of the server apparatus 110. The predetermined URL is the URL of a color validation service provided by the server apparatus 110.

In S1001, in response to access from the Web browser 1, the server apparatus 110 determines whether information (to be referred to as a measurement status hereinafter) representing a measurement status is stored in the measurement status storage unit 317. The measurement status is information representing that the measurement processing is in progress. More specifically, for example, the measurement status is information including the identification information of the measurement processing.
A case where it is determined that the measurement status is not stored will be described. If it is determined that the measurement status is not stored, the process advances to S1002.

In S1002, the server apparatus 110 determines whether to perform the measurement processing from the beginning (newly) or from the middle. In this example, based on the determination that the measurement status is not stored, it is determined to perform the measurement processing from the beginning.

In S1003, the server apparatus 110 transmits, to the Web browser 1, the Web page 302 of a screen capable of accepting a measurement start instruction, which includes the Web component 303. The screen capable of accepting a measurement start instruction is, for example, the measurement setting selection screen shown in FIG. 6A.

In S1004, the Web browser 1 executes the Web component 303 to display the measurement setting selection screen and accept a measurement start instruction from the user. In S1005, the Web browser 1 transmits a measurement instruction to the server apparatus 110 together with the identification information of the measurement processing.

In S1006, with reference to the measurement setting storage unit 313, the server apparatus 110 creates a chart measurement request based on the measurement settings corresponding to the identification information of the measurement processing transmitted from the Web browser 1. Then, the server apparatus 110 stores the measurement status indicating that the measurement processing is in progress in the measurement status storage unit 317.

In S1007, the server apparatus 110 transmits the created chart measurement request, the identification information of the measurement processing, and the Web page 302 of the measurement preparation screen including the Web component 303 to the Web browser 1. In S1008, the Web browser 1 executes the Web component 303 to display a measurement preparation screen. The measurement preparation screen is, for example, the measurement preparation screen shown in FIG. 6B. In S1009, the Web browser 1 establishes connection to the server apparatus 110. In S1010, the server apparatus 110 transmits, to the Web browser 1, the Web page 302 of the measurement preparation screen on which a list of measurement devices transmitted from the Web browser 1 has been reflected.

In S1011, the Web browser 1 displays the measurement preparation screen on which the list of measurement devices has been reflected, and accepts selection of the measurement device from the user. Then, the Web browser 1 transmits information of the selected measurement device to the server apparatus 110.

In S1012, the server apparatus 110 transmits, to the Web browser 1, the Web page 302 of the chart measurement screen corresponding to the selected measurement device, which includes the Web component 303. In S1013, the Web browser 1 executes the transmitted Web component 303 to display a chart measurement screen. The chart measurement screen is, for example, the chart measurement screen shown in FIG. 7A. Upon accepting selection of a patch on the chart preview 612 of the chart measurement screen, the Web browser 1 performs measurement of the patch in cooperation with the measurement control unit 304 of the on-premise application 301, as will be described in S1014 to S1016 below. The patch selected by the user is a measurement target patch.

In S1014, the Web browser 1 executes the Web component 303 to transmit a patch measurement request corresponding to the selected patch to the measurement control unit 304 of the on-premise application 301. At this time, the IP address of the server apparatus 110 that the Web browser 1 is accessing is transmitted.

In S1015, the user performs measurement of the patch using the measurement device 107, and the measurement control unit 304 of the on-premise application 301 receives a measurement value from the measurement device 107 via the measurement device cooperation unit 306. Then, the measurement control unit 304 stores the measurement value of the patch as a patch measurement result in the patch measurement result storage unit 310 together with the identification information, and transmits the measurement value of the patch to the Web component 303. The patch measurement result is stored in association with the IP address of the server apparatus 110. Based on the patch measurement result received from the measurement control unit 304, the Web component 303 determines whether the measurement has succeeded or failed. More specifically, for example, if the measurement result (Result) of the patch measurement result is “true”, the Web component 303 determines that the measurement of the patch has succeeded, and if the measurement result is “false”, the Web component 303 determines that the measurement of the patch has failed.

In S1016, the Web browser 1 executes the Web component 303 to perform display corresponding to the measurement value (lab-value) of the patch measurement result in each cell of the patch selected on the chart preview 612, which is the guest content. Note that as display corresponding to the measurement value, for example, a numerical value may be displayed or a color corresponding to the measurement value may be displayed. Alternatively, for example, a color corresponding to the measurement value may be displayed for each patch, and when a cursor is superimposed on the color, the measurement value of the patch may be displayed by a numerical value.

In S1017, the Web browser 1 executes the Web component 303 to determine whether measurement for all the patches on the chart preview 612 has finished. If it is determined that measurement for all the patches has finished, the process advances to S1018.
A case where it is determined that measurement for all the patches has finished will be described.

In S1018, the Web browser 1 executes the Web component 303 to transmit, upon the pressing of the finish measurement button 611 on the chart measurement screen, a measurement result transmission instruction to the measurement control unit 304 of the on-premise application 301.

The measurement control unit 304 of the on-premise application 301 stores, in S1019, the measurement result in the measurement result storage unit 309 based on identification information (for example, “000001”) included in the measurement result transmission instruction, and transmits, in S1020, the measurement result to the Web server 311 via the measurement communication unit 305. When transmitting the measurement result to the Web server 311, the measurement control unit 304 performs authentication using authentication information used to access in S1000, and after authentication succeeds, transmits the measurement result.

In S1021, the Web browser 1 executes the Web component 303 to instruct the measurement control unit 304 of the on-premise application 301 to delete the patch measurement result. The measurement control unit 304 receives an instruction of the Web component 303, and deletes the patch measurement result from the patch measurement result storage unit 310. In S1022, the server apparatus 110 stores the received measurement result in the measurement setting storage unit 313, and deletes the measurement status in the measurement status storage unit 317.
A case where it is determined in S1017 that measurement for all the patches has not finished will be described. If it is determined in S1017 that measurement for all the patches has not finished, the process advances to S1023.

In S1023, the Web browser 1 determines whether the connection to the server apparatus 110 has been disconnected. Disconnection of the connection to the server apparatus 110 is specifically, for example, disconnection caused by a time-out.
A case where it is determined that the connection to the server apparatus 110 has not been disconnected will be described. If it is determined that the connection to the server apparatus 110 has not been disconnected, the process advances to S1024.

In S1024, the Web browser 1 determines whether switching of the server apparatus 110 as the connection destination of the on-premise application 301 has occurred. More specifically, for example, the determination processing is performed based on event detection indicating that a mouse focus moves from the current Web browser 1 and control shifts to the other Web browser n.
A case where it is determined that switching of the server apparatus 110 has not occurred will be described. If it is determined that switching of the server apparatus 110 has not occurred, the processes from S1013 are repeated. If it is determined in S1017 that measurement for all the patches has finished as a result of repeating the processes from S1013, the processes in S1018 to S1022 are executed.
A case where it is determined in S1023 that the connection to the server apparatus 110 has been disconnected will be described. If it is determined that the connection to the server apparatus 110 has been disconnected, the process advances to S1025.

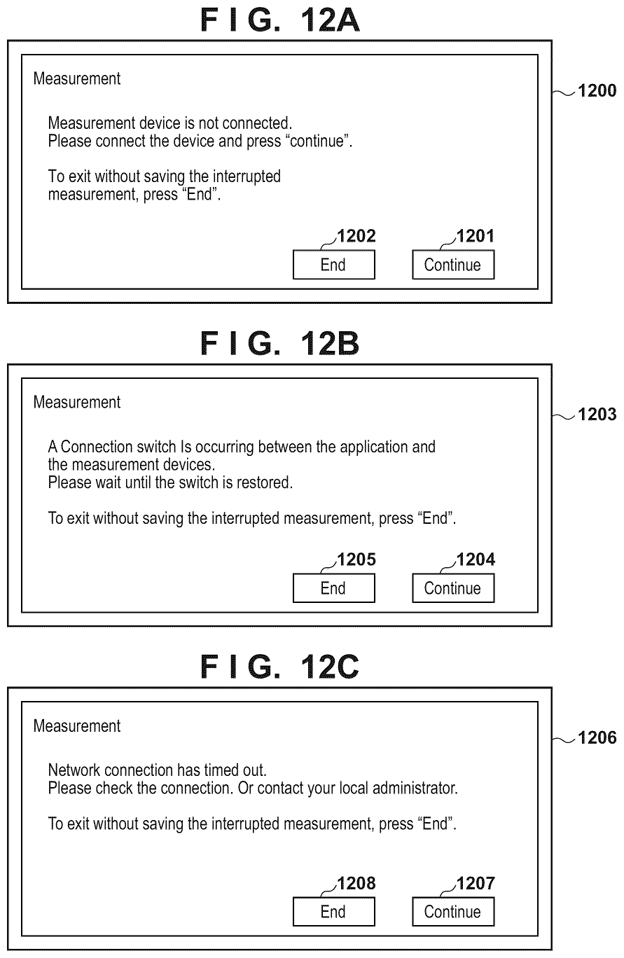

In S1025, the Web browser 1 displays, on the display screen of the on-premise application 301, a message screen indicating that the connection is currently disconnected. The message screen is, for example, a screen 1206 shown in FIG. 12C. In addition to the message indicating that the connection is currently disconnected, the screen 1206 shown in FIG. 12C includes a button 1208 capable of accepting an instruction to delete the patch measurement result stored in S1015 by the on-premise application 301 on the Web browser 1, and a button 1207 capable of accepting an instruction to continue a state in which the patch measurement result is stored in S1015. When the button 1208 is pressed, the patch measurement result stored in S1015 is deleted, and the screen is closed. When the button 1207 is pressed, the screen is closed as is.

<Case where Re-Accessing is Performed after Disconnection from Server Apparatus 110>

Next, a case where the Web browser 1 re-accesses the server apparatus 110 after it is determined in S1023 that the connection to the server apparatus 110 has been disconnected will be described. This corresponds to, for example, a case where the user re-accesses the server apparatus 110 using the Web browser 1 while viewing the screen 1206 shown in FIG. 12C. In this case, the processing in S1000 is executed again.

After S1000, the determination processing in S1001 is performed. In this case, the measurement status is already stored in the measurement status storage unit 317 in S1006. Therefore, it is determined in S1001 that the measurement status is stored, and the process advances to S1027.

In S1027, the color validation management unit 312 of the server apparatus 110 transfers the Web page 302 including the Web component 303 for determination to the Web server 311. The Web server 311 transmits the Web page 302 to the Web browser 1. The Web page 302 is not used by the Web browser 1 for the purpose of displaying content. The Web page 302 is transmitted to transmit the Web component 303 to the Web browser 1 to perform determination processing of whether the identification information matches and determination processing of whether the measurement device 107 is connected. In S1028, the Web browser 1 executes the Web component 303 to execute the determination processing of whether the identification information matches and the determination processing of whether the measurement device 107 is connected. The determination processing of whether the identification information matches and the determination processing of whether the measurement device 107 is connected will be described later. In other words, the determination processing of whether the identification information matches is processing of determining whether the patch measurement result corresponding to the server apparatus 110 is stored in the patch measurement result storage unit 310. In this case, since the patch measurement result already stored in S1015 corresponds to the server apparatus 110, it is determined that the patch measurement result corresponding to the server apparatus 110 is stored, and the determination result is transmitted to the server apparatus 110.

In S1002, based on the determination result transmitted in S1028, it is determined to perform the measurement processing from the middle, and the process advances to S1101 of FIG. 11A.

In S1101, the server apparatus 110 creates, based on the stored measurement status, a chart measurement request based on the measurement settings corresponding to the identification information. In S1102, the color validation management unit 312 of the server apparatus 110 transmits the created chart measurement request and the Web page 302 of the chart measurement screen including the Web component 303 to the Web browser 1 via the Web server 311.

In S1103, the Web browser 1 executes the Web component 303 to perform restoration processing (redisplay of the measurement value) of the patch measurement result in cooperation with the measurement control unit 304. The Web browser 1 executes the Web component 303 to instruct the measurement control unit 304 of the on-premise application 301 to restore the patch measurement result.

In S1104, the measurement control unit 304 transmits the patch measurement results stored in the patch measurement result storage unit 310 to the Web component 303 one by one. At this time, if all the patch measurement results have been transmitted, the measurement control unit 304 also transmits a restoration finish flag.

In S1105, the Web browser 1 executes the Web component 303 to perform restoration processing for each of the patch measurement results transmitted from the measurement control unit 304. That is, upon receiving the patch measurement result from the measurement control unit 304, the Web component 303 performs determination processing of the measurement result. More specifically, for example, if the measurement result (Result) of the patch measurement result is “true”, the Web component 303 determines that the measurement of the patch has succeeded, and if the measurement result is “false”, the Web component 303 determines that the measurement of the patch has failed. Then, the Web component 303 displays a value corresponding to the measurement value (lab-value) of the patch measurement result in each cell of the patch selected on the chart preview 612, which is the guest content. As the corresponding value, a numerical value may be displayed or a color corresponding to the measurement value may be displayed. The screen displayed here is, for example, the chart measurement screen shown in FIG. 7A. Alternatively, a color corresponding to the measurement value may be displayed for each patch, and when a cursor is superimposed on the color, the measurement value of the patch may be displayed as a numerical value.

As described above, according to this embodiment, with the restoration processing, the progress of the measurement processing for each patch by the Web browser 1, which has been interrupted by disconnection of the connection to the server apparatus 110, is reproduced and displayed.

In S1106, the Web browser 1 executes the Web component 303 to determine, based on whether the restoration finish flag has been transmitted together with the patch measurement result, whether the restoration processing has finished. If it is determined that the restoration processing has finished, the process advances to S1107. If it is determined that the restoration processing has not finished, the processes from S1105 are repeated. In S1107, the Web browser 1 determines whether the measurement has finished.
A case where it is determined that the measurement has not finished will be described. If it is determined that the measurement has not finished, the process advances to S1108.

In S1108, S1109, S1110, S1111, and S1112, the same processes as in S1013, S1014, S1015, and S1016 are executed. That is, measurement of the patch is performed in cooperation with the measurement control unit 304 of the on-premise application 301. In S1105, with respect to the patch for which the measurement ends before disconnection of the connection to the server apparatus 110 by the restoration processing, the measurement value is displayed. Therefore, in S1108, the user can readily select the subsequent patch after the interruption and resume the measurement.

In S1113, the Web browser 1 determines whether measurement for all the patches on the chart preview 612 has finished. In S1113, the same processing as in S1017 is performed. If it is determined that measurement for all the patches has finished, processes in S1114, S1115, S1116, S1117, and S1118 are executed. These processes are the same as in S1018, S1019, S1020, S1021, and S1022. Even if it is determined in S1107 that the measurement has finished, the processes in S1114, S1115, S1116, S1117, and S1118 are executed.

If it is determined in S1113 that measurement for all the patches has not finished, the process advances to S1119. In S1119, the Web browser 1 determines whether the connection to the server apparatus 110 has been disconnected. Disconnection of the connection to the server apparatus 110 is specifically, for example, disconnection caused by a time-out.
A case where it is determined that the connection to the server apparatus 110 has not been disconnected will be described. If it is determined that the connection to the server apparatus 110 has not been disconnected, the process advances to S1120.

In S1120, the Web browser 1 determines whether switching of the server apparatus 110 as the connection destination of the on-premise application 301 has occurred.
A case where it is determined that switching of the server apparatus 110 has not occurred will be described. If it is determined that switching of the server apparatus 110 has not occurred, the processes from S1108 are repeated. If, by repeating the processes from S1108, it is determined in S1113 that measurement for all the patches has finished, the processes in S1114 to S1118 are executed.
A case where it is determined in S1119 that the connection to the server apparatus 110 has been disconnected will be described. If it is determined that the connection to the server apparatus 110 has been disconnected, the process advances to S1121.

In S1121, the Web browser 1 displays, on the display screen of the on-premise application 301, a message screen indicating that the connection is currently disconnected. The message screen is, for example, the screen 1206 shown in FIG. 12C. In addition to the message indicating that the connection is currently disconnected, the screen 1206 shown in FIG. 12C includes the button 1208 capable of accepting an instruction to delete the patch measurement results stored in S1015 and S1110 by the on-premise application 301 in correspondence with the Web browser 1, and the button 1207 capable of accepting an instruction to continue a state in which the patch measurement results are stored in S1015 and S1110. When the button 1208 is pressed, the patch measurement results stored in S1015 and S1110 are deleted, thereby closing the screen. When the button 1207 is pressed, the screen is closed as is. If the Web browser 1 re-accesses the server apparatus 110 after it is determined in S1119 that the connection to the server apparatus 110 has been disconnected, the processes from S1000 described above are repeated.

<Case where Server Apparatus as Connection Destination of On-Premise Application 301 has been Switched>

Next, a case where the server apparatus as the connection destination of the on-premise application 301 has been switched will be described. This corresponds to, for example, a case where it is determined in S1024 that switching of the server apparatus 110 as the connection destination of the on-premise application 301 has occurred. The determination processing in S1024 is performed based on event information acquired from the OS by the Web browser. More specifically, for example, the determination processing is performed based on event detection indicating that a mouse focus moves from the current Web browser 1 and control shifts to the other Web browser n. Assume here that switching from the Web browser 1 to the Web browser n has occurred. In other words, the Web browser 1 changes from an enabled state to a disabled state, and the Web browser n changes from a disabled state to an enabled state.

If the above event is detected, the Web browser 1 displays, in S1026, a message screen indicating that the server apparatus 110 as the connection destination has been switched. The screen displayed here is, for example, a screen 1203 shown in FIG. 12B. Data of the screen 1203 shown in FIG. 12B may be, for example, data transmitted to the Web browser 1 from the Web server 311 that has received an event detection notification from the Web browser 1.

In addition to the message indicating that the server apparatus 110 as the connection destination has been switched, the screen 1203 shown in FIG. 12B includes a button 1205 capable of accepting an instruction to delete the patch measurement result stored in S1015 by the on-premise application 301 in correspondence with the Web browser 1, and a button 1204 capable of accepting an instruction to continue a state in which the patch measurement result is stored in S1015. When the button 1205 is pressed, the patch measurement result stored in S1015 is deleted, thereby closing the screen. When the button 1204 is pressed, the Web browser 1 is set in a switching state (waiting state) in S1029. Thus, the user can be notified that the server apparatus is switched in the middle of the measurement. If, for example, switching from the Web browser n to the Web browser 1 occurs again, and the Web browser 1 is enabled, the processing in S1029 ends and the processes from S1000 are repeated. After that, the same processing as that described in <Case Where Re-Accessing Is Performed After Disconnection from Server Apparatus 110> is executed.

Processing in the Web browser n will be described next. In S1030, based on, for example, the fact that the mouse focus is placed on the Web browser n, the Web browser n detects that it is enabled. In S1031, the Web browser n transmits, to the on-premise application 301, the IP address of the server apparatus 110 which the Web browser n is accessing, and also requests the on-premise application 301 to perform restoration processing of the patch measurement result. Note that at this time, the Web browser n may display a screen capable of accepting an instruction of whether to execute restoration processing or to execute the measurement processing from the beginning.

In S1032, the on-premise application 301 interrupts processing of storing the chart measurement result, which is performed by the Web browser 1 before switching. At this time, the patch measurement result has been stored in S1015 in the patch measurement result storage unit 310 in association with the identification information and the IP address of the server apparatus 110. In S1033, the on-premise application 301 performs stop processing of the measurement device 107 in order to switch the server apparatus 110 as the connection destination of the measurement device 107.

In S1034, the on-premise application 301 searches the patch measurement result storage unit 310 for the measurement result corresponding to the IP address received in S1031. If there exists the corresponding measurement result, the on-premise application 301 restores the measurement result in S1035. At this time, the same processes as in S1104 and S1105 are performed. Since the measurement result is linked with the setting information of the measurement device 107 at the time of execution of the measurement, the on-premise application 301 acquires the setting information and sets it in the measurement device 107 in S1036. In S1037, the on-premise application 301 resumes the operation of the measurement device 107. In S1038, the on-premise application 301 notifies the Web browser n of end of the restoration.

After S1038, the Web browser n executes the same processes as those from S1000 executed by the Web browser 1. That is, if re-accessing is performed after disconnection of the connection to the server apparatus 110 corresponding to the Web browser n, the Web browser n executes the same processing as that described in <Case Where Re-Accessing Is Performed After Disconnection from Server Apparatus 110>. If the Web browser is switched, the Web browser performs the same processing as that described in <Case Where Server Apparatus as Connection Destination of On-Premise Application 301 Has Been Switched>.
A case where it is determined in S1120 that switching of the server apparatus 110 as the connection destination of the on-premise application 301 has occurred will be described. In this case, the process advances from S1120 to S1122. Assume here that switching from the Web browser 1 to the Web browser n has occurred.

In S1122, the Web browser 1 displays a message screen indicating that the server apparatus 110 as the connection destination has been switched. The screen displayed here is, for example, the screen 1203 shown in FIG. 12B. Data of the screen 1203 shown in FIG. 12B is, for example, data transmitted to the Web browser 1 from the Web server 311 that has received an event detection notification from the Web browser 1.

In addition to the message indicating that the server apparatus 110 as the connection destination has been switched, the screen 1203 shown in FIG. 12B includes the button 1205 capable of accepting an instruction to delete the patch measurement results stored in S1015 and S1110 by the on-premise application 301 in correspondence with the Web browser 1, and the button 1204 capable of accepting an instruction to continue a state in which the patch measurement results are stored in S1015 and S1110. When the button 1205 is pressed, the patch measurement results stored in S1015 and S1110 are deleted, thereby closing the screen. When the button 1204 is pressed, the Web browser 1 is set in a switching state (waiting state) in S1123. Thus, the user can be notified that the server apparatus is switched in the middle of the measurement. If, for example, switching from the Web browser n to the Web browser 1 occurs again, and the Web browser 1 is enabled, the processing in S1123 ends and the processes from S1000 are repeated. After that, the same processing as that described in <Case Where Re-Accessing Is Performed After Disconnection from Server Apparatus 110> is executed.

Processing in the Web browser n in S1124 will be described next. In S1124, based on, for example, the fact that the mouse focus is placed on the Web browser n, the Web browser n detects that it is enabled. In S1125, the Web browser n transmits, to the on-premise application 301, the IP address of the server apparatus 110 which the Web browser n is accessing, and also requests the on-premise application 301 to perform restoration processing of the patch measurement result. Note that at this time, the Web browser n may display a screen capable of accepting an instruction of whether to execute restoration processing or to execute the measurement processing from the beginning.

The on-premise application 301 executes processes in S1126 to S1132, similar to the description of S1032 to S1038.

After S1132, the Web browser n executes the same processes as those from S1000 executed by the Web browser 1. That is, if re-accessing is performed after disconnection of the connection to the server apparatus corresponding to the Web browser n, the Web browser n executes the same processing as that described in <Case Where Re-Accessing Is Performed After Disconnection from Server Apparatus 110>. If the Web browser is switched, the Web browser performs the same processing as that described in <Case Where Server Apparatus as Connection Destination of On-Premise Application 301 Has Been Switched>.

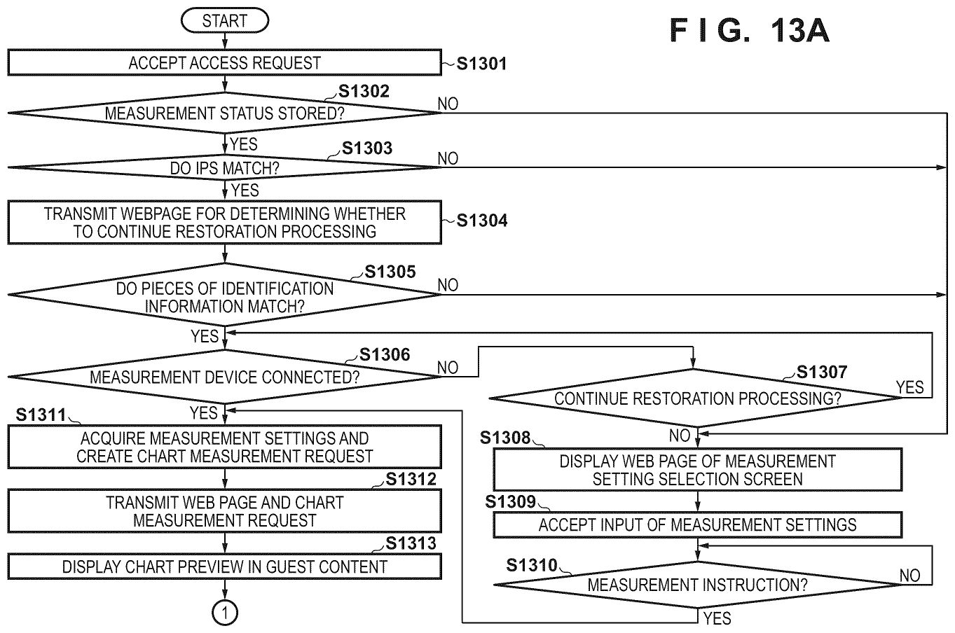

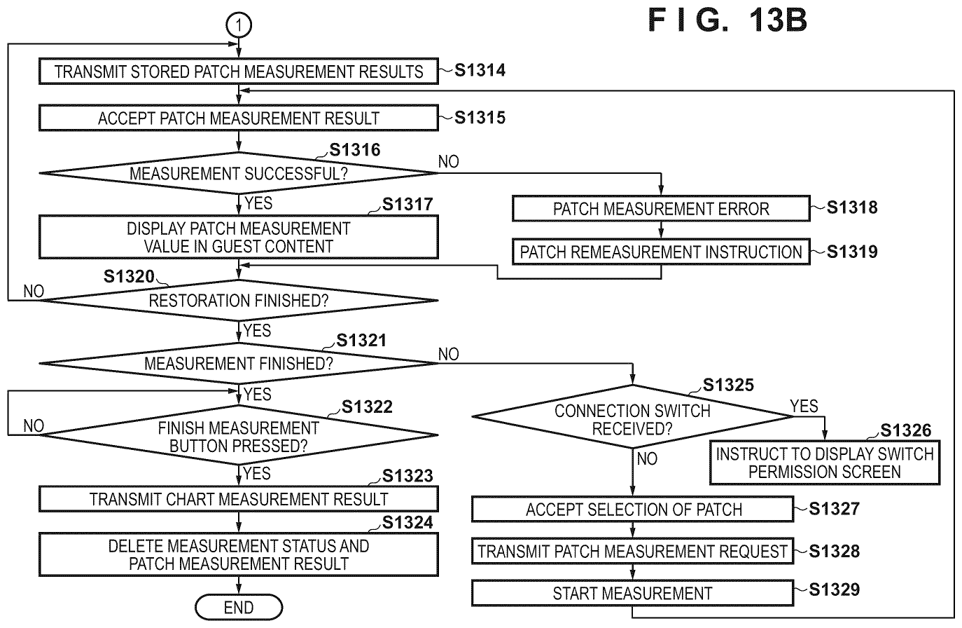

FIGS. 13A and 13B are flowcharts for explaining the procedure of the measurement processing according to this embodiment, and includes the restoration processing described in the processing shown in FIGS. 10 and 11. The following processing is implemented when the CPU 201 of each of the server apparatus 110 and the client apparatus 104 reads out a program stored in the ROM 203 to the RAM 202 and executes it.

In step S1301, the Web server 311 of the server apparatus 110 accepts connection processing from the Web browser 300 of the client apparatus 104. This corresponds to, for example, S1000 of FIG. 10A.

In step S1302, the color validation management unit 312 of the server apparatus 110 determines whether the measurement status is stored in the measurement status storage unit 317. If it is determined that the measurement status is stored, the process advances to step S1303. If it is determined that the measurement status is not stored, the process advances to step S1308. Note that if the measurement status is not stored in linkage with the IP address of the client apparatus 104 in the measurement status storage unit 317, the process may skip step S1303 and advance to step S1304. If a predetermined time elapses since measurement is performed, it is determined that the state of a printing apparatus that has printed a chart has also changed, and the measurement status stored in the measurement status storage unit 317 of the server apparatus 110 and the patch measurement result stored in the patch measurement result storage unit 310 of the client apparatus 104 may be deleted. To do this, the server apparatus 110 may transmit the Web page 302 including the Web component 303 to the Web browser 300 via the Web server 311, and delete the patch measurement result. More specifically, for example, if a predetermined time elapses since measurement is performed, for example, a predetermined time elapses since the measurement status is stored, the server apparatus 110 deletes the measurement status in the measurement status storage unit 317. Then, the server apparatus 110 transmits, to the Web browser 300 of the client apparatus 104, the Web page 302 including the Web component 303 for deleting the patch measurement result, and deletes the stored patch measurement result.

In step S1303, the color validation management unit 312 of the server apparatus 110 determines whether the IP address of the client apparatus 104 on which the Web browser 300 for which the connection processing has been accepted operates matches any of one or a plurality of IP addresses stored in the measurement status storage unit 317. If it is determined that the IP address matches any of the IP addresses, the process advances to step S1304. If it is determined that the IP address does not match any of the IP addresses, the process advances to step S1308. The IP address is the IP address of the client apparatus 104 that performs the measurement processing, and is a part of the context used in the measurement processing. Steps S1302 and S1303 correspond to, for example, S1001 of FIG. 10A.

In step S1304, the color validation management unit 312 of the server apparatus 110 transfers the Web page 302 including the Web component 303 for determination to the Web server 311. The Web server 311 transmits the Web page 302 to the Web browser 300 of the client apparatus 104. As described above, the Web page 302 is transmitted for the purpose of transmitting, to the Web browser 300, the Web component 303 for performing determination processing, in step S1305, of whether the identifier matches and determination processing, in step S1306, of whether the measurement device 107 is connected. The Web browser 300 as the transmission destination is a Web browser operating on the client apparatus 104 having the IP address determined, in step S1303, to match any of the IP addresses. The identification information stored in the measurement status storage unit 317 is a part of content transmitted to the Web browser 300.

In step S1305, the Web browser 300 of the client apparatus 104 executes the Web component 303 to inquire of the measurement control unit 304 about the identification information of the patch measurement result stored in the patch measurement result storage unit 310. The measurement control unit 304 acquires the identification information of the patch measurement result stored in the patch measurement result storage unit 310, and notifies the Web component 303 of it. The Web component 303 determines whether the identification information acquired from the patch measurement result storage unit 310 matches the identification information transmitted from the server apparatus 110 in step S1304 and stored in the measurement status storage unit 317. If it is determined that these pieces of identification information match each other, the process advances to step S1306. If it is determined that these pieces of identification information do not match each other, information indicating that these pieces of identification information do not match each other is transmitted to the color validation management unit 312 via the Web server 311 of the server apparatus 110, and the process advances to step S1308. In other words, a case where the process advances from step S1305 to step S1308 indicates a case where a mismatch occurs between the data stored in the measurement status storage unit 317 of the server apparatus 110 and the data stored in the patch measurement result storage unit 310 of the client apparatus 104.

If it is determined in step S1305 that the pieces of identification information match each other, in other words, if consistency is achieved between the data stored in the measurement status storage unit 317 of the server apparatus 110 and the data stored in the patch measurement result storage unit 310 of the client apparatus 104, the process advances to step S1306. In step S1306, the Web browser 300 of the client apparatus 104 executes the Web component 303 to determine whether the measurement device 107 is connected to the measurement control unit 304. If it is determined that the measurement device 107 is connected, the Web browser 300 of the client apparatus 104 executes the Web component 303 to notify, via the Web server 311 of the server apparatus 110, the color validation management unit 312 that the restoration processing is possible, and advances to step S1311. On the other hand, if it is determined that the measurement device 107 is not connected, the process advances to step S1307. Steps S1305 and S1306 correspond to S1028 of FIG. 10A.

In step S1311, the color validation management unit 312 of the server apparatus 110 creates a chart measurement request based on the measurement settings with reference to the identification information of the measurement processing stored in linkage with the measurement status. In step S1312, the color validation management unit 312 of the server apparatus 110 transmits the created chart measurement request and the Web page 302 of the chart measurement screen including the Web component 303 to the Web browser 1 via the Web server 311. This corresponds to, for example, S1101 of FIG. 11A.

In step S1313, the Web browser 300 of the client apparatus 104 executes the transmitted Web component 303 to display a chart measurement screen. The chart measurement screen is, for example, the chart measurement screen shown in FIG. 7A.

In step S1314, the Web browser 300 of the client apparatus 104 executes the Web component 303 to instruct the measurement control unit 304 to restore the patch measurement result. This corresponds to, for example, S1103 of FIG. 11A. The measurement control unit 304 transmits the patch measurement results stored in the patch measurement result storage unit 310 to the Web component 303 one by one. At this time, if all the patch measurement results have been transmitted, the measurement control unit 304 also transmits a restoration finish flag. This corresponds to, for example, S1104 of FIG. 11A. In step S1315, the Web browser 300 of the client apparatus 104 executes the Web component 303 to receive, one by one, the patch measurement results transmitted from the measurement control unit 304. With restoration processing in steps S1316 to S1320 below, measurement values are displayed for up to patches having undergone the measurement. Steps S1316 to S1320 correspond to, for example, S1105 of FIG. 11A.

In step S1316, the Web browser 300 of the client apparatus 104 executes the Web component 303 to perform determination processing of the measurement result. More specifically, for example, if the measurement result (Result) of the patch measurement result is “true”, the Web component 303 determines that the measurement of the patch has succeeded, and advances to step S1317, and if the measurement result is “false”, the Web component 303 determines that the measurement of the patch has failed, and advances to step S1318.

In step S1317, the Web browser 300 of the client apparatus 104 executes the Web component 303 to display a value corresponding to the measurement value (lab-value) of the patch measurement result in each cell of the patch selected on the chart preview 612, which is the guest content. The measurement value may be displayed by a numerical value or a color corresponding to the measurement value may be displayed. Alternatively, a color corresponding to the measurement value may be displayed for each patch, and when a cursor is superimposed on the color, the measurement value of the patch may be displayed by a numerical value.

In step S1318, the Web browser 300 of the client apparatus 104 executes the Web component 303 to display a warning message of a patch measurement error on the chart preview 612. In step S1319, the Web browser 300 of the client apparatus 104 executes the Web component 303 to display a button capable of accepting a patch remeasurement instruction on the chart preview 612.

In step S1320, the Web browser 300 of the client apparatus 104 executes the Web component 303 to determine, based on whether the restoration finish flag has been transmitted together with the patch measurement result, whether the restoration processing has finished. If it is determined that the restoration processing has finished, the process advances to step S1321. If it is determined that the restoration processing has not finished, the processes from step S1314 are repeated. This corresponds to, for example, S1106 of FIG. 11A.

In step S1321, the measurement control unit 304 of the client apparatus 104 determines whether the measurement has finished. If it is determined that the measurement has finished, the process advances to step S1322, and if it is determined that the measurement has not finished, the process advances to step S1325. This corresponds to, for example, S1107 of FIG. 11A.

In step S1325, the Web server 311 of the server apparatus 110 determines whether the server apparatus 110 as the connection destination has been switched in the client apparatus 104. This corresponds to, for example, S1120. If it is determined that the server apparatus 110 as the connection destination has not been switched, processes in steps S1327, S1328, and S1329 are performed, and the process returns to step S1315. Steps S1327, S1328, and S1329 correspond to S1108, S1109, and S1110 of FIG. 11A. On the other hand, if it is determined that the server apparatus 110 as the connection destination has been switched, the Web browser 300 displays, in step S1326, a screen indicating that the server apparatus 110 as the connection destination has been switched. This corresponds to, for example, S1122 of FIG. 11B.

If it is determined in step S1321 that the measurement has finished, processes in steps S1322 and S1323 are performed. These processes correspond to, for example, S1114 and S1116 of FIG. 11B. Then, in step S1324, the Web browser 300 executes the Web component 303 to instruct the measurement control unit 304 to delete the patch measurement result. Upon receiving the instruction of the Web component 303, the measurement control unit 304 deletes the patch measurement result from the patch measurement result storage unit 310. This corresponds to, for example, S1117 of FIG. 11B. The color validation management unit 312 may store the chart measurement result in accordance with reception of it, and delete the measurement status of the measurement processing associated with the measurement result.

If it is determined in step S1306 that the measurement device 107 is not connected, the Web browser 300 executes, in step S1307, the Web component 303 to determine whether to execute the restoration processing. More specifically, for example, when a message screen 1200 shown in FIG. 12A is displayed and a continue button 1201 is pressed, the process advances to step S1306, and stands by for connection of the measurement device 107. On the other hand, when an end button 1202 is pressed, the process advances to step S1308. Note that if the process advances to step S1308, processing in step S1324 may be executed.

Processing in a case where the process advances to step S1307 is not shown in FIGS. 10 and 11. However, with the above configuration, if a state in which the restoration processing is performed is not set when re-accessing is performed after disconnection of the connection to the server apparatus 110, a screen capable of accepting an instruction of whether to execute (continue) the restoration processing can be displayed. If the state in which the restoration processing is performed is set, the restoration processing is performed without intervention of a user operation, and it is thus possible to improve convenience.

If it is determined in step S1302 that the measurement status is not stored, if it is determined in step S1303 that the IP address does not match any of the IP addresses, or if it is determined in step S1305 that the pieces of identification information do not match each other, the process advances to step S1308. In step S1308, the Web browser 300 executes the Web component 303 to notify, via the Web server 311, the color validation management unit 312 that the restoration processing has failed. The color validation management unit 312 transmits the Web page 302 of the measurement setting selection screen shown in FIG. 6A to the Web browser 300 via the Web server 311. The Web browser 300 displays the received Web page 302. After that, processes in steps S1309 and S1310 are performed. The processes in steps S1309 and S1310 are the same as those in steps S900 and S901.

As described above, in the configuration in which the program operating on the Web server and the Web browser and the on-premise application communicate with each other, it is possible to restore the measurement result at the time of returning from an unintended network disconnection. More specifically, for example, when the Web component is executed to execute the restoration processing by the cooperative operation of the Web server and the on-premise application without intervention of a user operation, the measurement result can be redisplayed. Note that although not shown in FIGS. 13A and 13B, in a case where the network between the server apparatus and the client apparatus is disconnected, the server apparatus 110 sends no instruction, and thus the screen shown in FIG. 12C may be displayed in the guest content on the side of the client apparatus 104.

This embodiment has been described as the configuration shown in FIG. 1B. However, even if the color validation system has a configuration shown in FIG. 1A, the operation of this embodiment is applicable.

FIG. 1A shows an example of another configuration of the color validation system. A server apparatus 102 exists on the side of an Internet cloud 101, and the client apparatus 104 exists in the local network 122 in the company. The local network 122 in the company and the Internet cloud 101 are connected via a network such as the Internet. Note that a plurality of systems 124 may be formed in the local network 122 in the company. In the system 124, the user operates a Web browser on the client apparatus 104 to operate the measurement device 107 connected to the client apparatus 104. Then, measurement processing is performed in cooperation with the server apparatus 102 on the side of the Internet cloud 101. The configuration shown in FIG. 1A is different from that shown in FIG. 1B that an image forming apparatus 106 is formed on the side of the client apparatus 104. Therefore, the print communication unit 307 and the print control unit 308 described with reference to FIG. 2 are formed in the on-premise application 301 of the client apparatus 104.

In the configuration shown in FIG. 1A, the print communication unit 307 relays communication between the Web server 311 and the print control unit 308 that controls the image forming apparatus 106. When the user sends a print instruction, the print communication unit 307 receives, from the Web server 311, a print job including print settings and print data, and the IP address of the image forming apparatus, and transfers them to the print control unit 308. Upon receiving the print job from the print communication unit 307, the print control unit 308 transmits the print job to the image forming apparatus 106 having the received IP address. As a method of transmitting the print job, for example, HTTP communication is used. As long as the print job is transmitted to the image forming apparatus 106, another print transmission method such as an LPR protocol or a hot folder may be used. In addition to the print job, data (PJL data or the like) for managing and controlling the image forming apparatus may be transmitted.

In the configuration shown in FIG. 1A, assume that the Web browser 300 of the client apparatus 104 is one Web browser corresponding to the server apparatus 102. That is, in the configuration shown in FIG. 1A, switching from the Web browser 1 to the Web browser n, as described with reference to FIGS. 10 and 11, is not assumed. However, the connection between the server apparatus 102 and the client apparatus 104 may be disconnected depending on the state of a network 100. In this case, the processes described with respect to the server apparatus 110, the Web browser 1, and the on-premise application 301 with reference to FIGS. 10 and 11 are applicable to the server apparatus 102, and the Web browser 1 and the on-premise application 301 of the client apparatus 104. Therefore, even if the color validation system is constructed with the configuration shown in FIG. 1A, it is possible to restore the measurement result.

Restoration of the measurement processing in the color validation system according to this embodiment has been explained above. A state in which measurement for all the patches on the chart has finished but the measurement result of the chart is not transmitted to the server apparatus 110 in S1020 or S1116 is assumed. In this case, the Web browser may be limited not to accept a request of another measurement processing. Alternatively, the Web browser may limit not to accept an instruction to perform measurement again from the user. This can prevent the measurement result from being overwritten by the measurement result of the other measurement processing in the patch measurement result storage unit 310. Alternatively, the patch measurement result storage unit 310 may be configured to store the measurement result independently for each of the plurality of measurement processes.

In this embodiment, the measurement status is stored as the context of the measurement in progress in the server apparatus 110. The IP address of the client apparatus 104 that executes the measurement processing is stored in the server apparatus 110. Then, with reference to this, the presence/absence of the measurement in progress is determined.

However, reference may be made to the patch measurement result stored in the client apparatus 104 as the context of the measurement processing. In this case, the measurement status and the IP address of the client apparatus 104 that executes the measurement processing need not be stored in the server apparatus 110. That is, when the client apparatus 104 accesses the server apparatus 110, the server apparatus 110 inquires, in response to the access, of the client apparatus 104 about whether the patch measurement result in the middle of the measurement and the identification information of the measurement processing are stored. Then, if a response from the client apparatus 104 indicates that these data are stored, the restoration processing is continued using the identification information received together with the response. For example, processing is executed from the processing in step S1304 of FIG. 13A. In this case, there may exist a plurality of measurement processes in progress in the client apparatus 104 that has accessed the server apparatus 110. In this case, the server apparatus 110 may cause the client apparatus 104 to prompt the user to select the measurement processing, and continue the restoration processing of the measurement processing in accordance with the selection.

Alternatively, if a predetermined period elapses since the measurement status is stored, the server apparatus 110 may delete the stored measurement status, and transmit, to the client apparatus 104, a deletion instruction of the measurement value for each patch. In this case, in accordance with the deletion instruction, the client apparatus 104 deletes the stored measurement value for each patch. Old measurement values during the measurement may be different from the current measurement values due to changes over time. Thus, with the above configuration, it is possible to prevent color misregistration or the like caused by reuse of old information.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-082895, filed May 21, 2024, which is hereby incorporated by reference herein in its entirety.

What is claimed is:

1. An information processing apparatus communicable with a plurality of servers, comprising
at least one memory and at least one processor causing the information processing apparatus to function as:
a measurement device control unit configured to control a measurement device to perform measurement for a measurement target and store a result of the measurement of the measurement device; and
a display control unit corresponding to each of the plurality of servers and configured to control to display the result of the measurement of the measurement device stored by the measurement device control unit,
wherein in a case where measurement corresponding to a first server among the plurality of servers is performed, the display control unit corresponding to the first server displays the result of the measurement of the measurement device, and
in a case where the measurement corresponding to the first server is switched to measurement corresponding to a second server, in a state in which the measurement corresponding to the first server is interrupted, the measurement device control unit stores the result of the measurement of the measurement device performed before the interruption.

2. The apparatus according to claim 1, wherein in a case where switching to the measurement corresponding to the first server occurs after the measurement corresponding to the first server is switched to the measurement corresponding to the second server, the display control unit corresponding to the first server controls to display the result of the measurement of the measurement device performed before the interruption.

3. The apparatus according to claim 2, wherein in a case where switching to the measurement corresponding to the first server occurs after the measurement corresponding to the first server is switched to the measurement corresponding to the second server, the display control unit corresponding to the first server controls to display a screen capable of accepting an instruction of whether to display the result of the measurement of the measurement device performed before the interruption.

4. The apparatus according to claim 3, wherein in a case where an instruction to display the result of the measurement of the measurement device performed before the interruption is accepted, the display control unit corresponding to the first server displays the result of the measurement of the measurement device performed before the interruption.

5. The apparatus according to claim 3, wherein in a case where the information processing apparatus is in a predetermined state, the display control unit corresponding to the first server controls to display a screen capable of accepting an instruction of whether to display the result of the measurement of the measurement device performed before the interruption.

6. The apparatus according to claim 5, wherein the predetermined state includes a state in which the measurement device is connected to the information processing apparatus.

7. The apparatus according to claim 2, wherein after the result of the measurement of the measurement device performed before the interruption is displayed, the measurement device control unit controls the measurement device to perform subsequent measurement corresponding to the first server.

8. The apparatus according to claim 1, wherein in a case where the measurement corresponding to the first server is switched to the measurement corresponding to the second server, the display control unit corresponding to the first server controls to display a screen indicating the interruption.

9. The apparatus according to claim 1, wherein in a case where a predetermined time elapses since the result of the measurement of the measurement device is stored, the measurement device control unit deletes the result of the measurement.

10. The apparatus according to claim 1, wherein in a case where connection between the first server and the information processing apparatus is disconnected, in a state in which the measurement corresponding to the first server is interrupted, the measurement device control unit stores the result of the measurement of the measurement device performed before the interruption.

11. The apparatus according to claim 10, wherein in the case where the connection between the first server and the information processing apparatus is disconnected, the display control unit corresponding to the first server controls to display a screen indicating the interruption.

12. The apparatus according to claim 1, wherein the measurement target is a chart including a plurality of patches.

13. The apparatus according to claim 12, wherein every time the measurement by the measurement device ends for each of the plurality of patches, the measurement device control unit controls to store a result of the ended measurement of the patch.

14. The apparatus according to claim 13, wherein
as the measurement corresponding to the first server, measurement is performed for the chart including the plurality of patches, and
in a state in which the measurement corresponding to the first server is interrupted, the measurement device control unit stores the result of the measurement of the patch performed before the interruption.

15. The apparatus according to claim 13, wherein in a case where the measurement is performed for the plurality of patches, the display control unit corresponding to the first server controls to transmit results of the measurement of the plurality of patches to the first server.

16. The apparatus according to claim 15, wherein the display control unit corresponding to the first server instructs the measurement device control unit to transmit the results of the measurement of the plurality of patches to the first server.

17. The apparatus according to claim 1, wherein each of the plurality of servers is a color validation server, and the measurement by the measurement device is processing included in a color validation process performed by the color validation server.

18. A method executed in an information processing apparatus communicable with a plurality of servers, comprising:
controlling a measurement device to perform measurement for a measurement target and storing a result of the measurement of the measurement device; and
controlling to display the stored result of the measurement of the measurement device in correspondence with each of the plurality of servers,
wherein in a case where measurement corresponding to a first server among the plurality of servers is performed, the result of the measurement of the measurement device is displayed in correspondence with the first server, and
in a case where the measurement corresponding to the first server is switched to measurement corresponding to a second server, in a state in which the measurement corresponding to the first server is interrupted, the result of the measurement of the measurement device performed before the interruption is stored.

19. A non-transitory computer-readable storage medium that stores one or more programs including instructions, which when executed by one or more processors of an information processing apparatus, cause the information processing apparatus to:
control a measurement device to perform measurement for a measurement target and store a result of the measurement of the measurement device; and
control to display the stored result of the measurement of the measurement device in correspondence with each of a plurality of servers,
wherein in a case where measurement corresponding to a first server among the plurality of servers is performed, the result of the measurement of the measurement device is displayed in correspondence with the first server, and
in a case where the measurement corresponding to the first server is switched to measurement corresponding to a second server, in a state in which the measurement corresponding to the first server is interrupted, the result of the measurement of the measurement device performed before the interruption is stored.
